(19) United States
(12) Patent Application Publication
(10) Pub. No.: US 2025/0142064 A1
(43) Pub. Date: May 1, 2025

(54) METHOD, APPARATUS, AND MEDIUM FOR VIDEO PROCESSING

(71) Applicant: Bytedance Inc., Los Angeles, CA (US)

(72) Inventors: Kai ZHANG, Los Angeles, CA (US); Li Zhang, Los Angeles, CA (US)

(21) Appl. No.: 19/009,816

(22) Filed: Jan. 3, 2025

Related U.S. Application Data
(63) Continuation of application No. PCT/US2023/069493, filed on Jun. 30, 2023.
(60) Provisional application No. 63/367,623, filed on Jul. 4, 2022.
(60) Provisional application No. 63/358,442, filed on Jul. 5, 2022.

(51) Int. Cl. H04N 19/117; H04N 19/186; H04N 19/70; H04N 19/80

(52) U.S. Cl. CPC H04N 19/117; H04N 19/186; H04N 19/70; H04N 19/80

(57) ABSTRACT

Embodiments of the disclosure provide a solution for video processing. A method for video processing is proposed. The method includes: generating, for a conversion between a video unit of a video and a bitstream of the video unit, a sample value of a first color component of the video unit that is corresponding to a sample of a second color component by applying a plurality of filters to at least one sample of the first color component; and performing the conversion based on the generated sample value.

### CROSS REFERENCE TO RELATED APPLICATIONS

This application is a continuation of International Application No. PCT/US2023/069493, filed on Jun. 30, 2023, which claims the benefit of U.S. Provisional Application No. 63/358,442 filed Jul. 5, 2022 and U.S. Provisional Application No. 63/367,623 filed Jul. 4, 2022. The entire contents of these applications are hereby incorporated by reference in their entireties.

### FIELDS

Embodiments of the present disclosure relates generally to video processing techniques, and more particularly, to self-aware filter estimation for cross component prediction in image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: generating, for a conversion between a video unit of a video and a bitstream of the video unit, a sample value of a first color component of the video unit that is corresponding to a sample of a second color component by applying a plurality of filters to at least one sample of the first color component; and performing the conversion based on the generated sample value. In this way, the filtering can be efficient, and the coding efficiency is improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: generating a sample value of a first color component of a video unit of the video that is corresponding to a sample of a second color component by applying a plurality of filters to at least one sample of the first color component; and generating the bitstream based on the generated sample value.

In a fifth aspect, a method for storing a bitstream of a video is proposed. The method comprises: generating a sample value of a first color component of a video unit of the video that is corresponding to a sample of a second color component by applying a plurality of filters to at least one sample of the first color component; generating the bitstream based on the generated sample value; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates 67 intra prediction modes;

FIG. 5 illustrates reference samples for wide-angular intra prediction;

FIG. 6 illustrates a problem of discontinuity in case of directions beyond 45°;

FIG. 7 illustrates Locations of the samples used for the derivation of α and β:

FIG. 8 illustrates luma sample down-sampling;

FIG. 9A and FIG. 9B illustrate flow charts of AFE-CCL, respectively;

FIG. 10 illustrates a flowchart of a method for video processing in accordance with embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

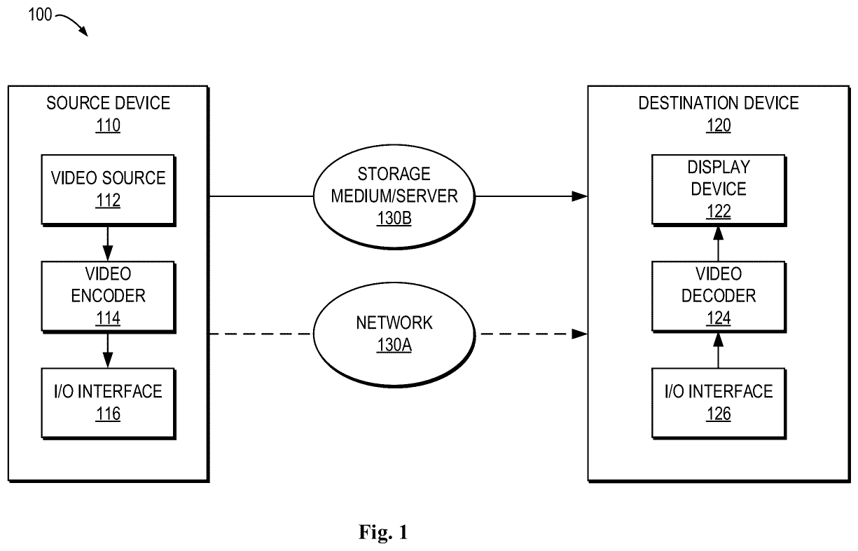

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

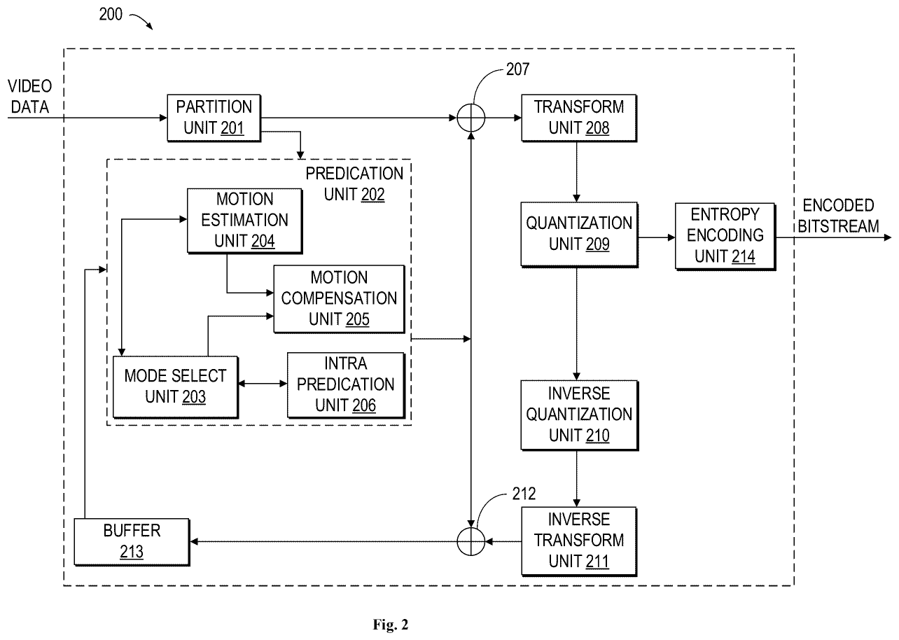

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

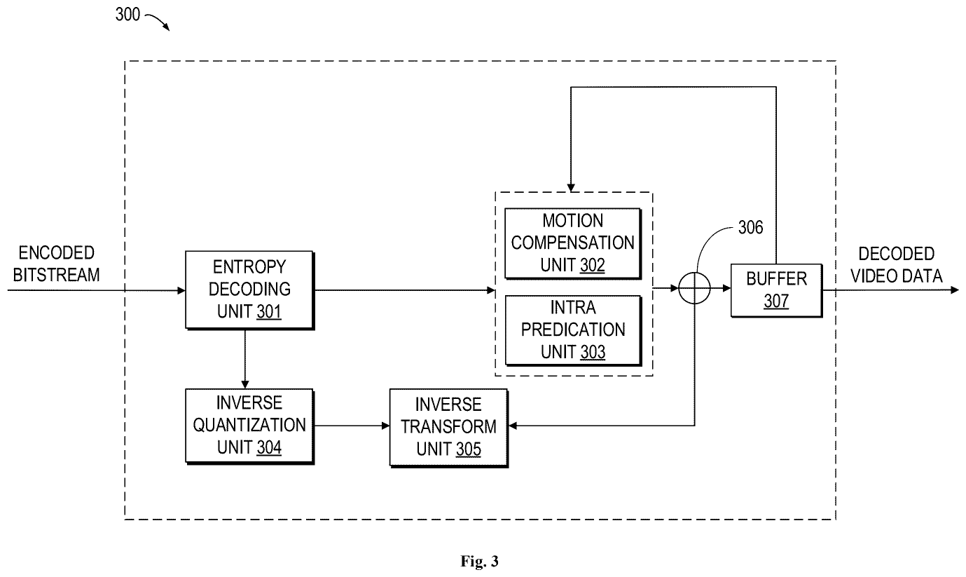

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

The present disclosure is related to video coding technologies. Specifically, it is related to intra prediction in video coding. The ideas may be applied individually or in various combination, to any image/video coding standard or non-standard image/video codec, e.g., next-generation image/video coding standard.

### 2 Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure where temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

2.1 Intra Prediction in VVC V1 (Extracted from JVET-R2002-v2)
2.1.1 Intra Mode Coding with 67 Intra Prediction Modes

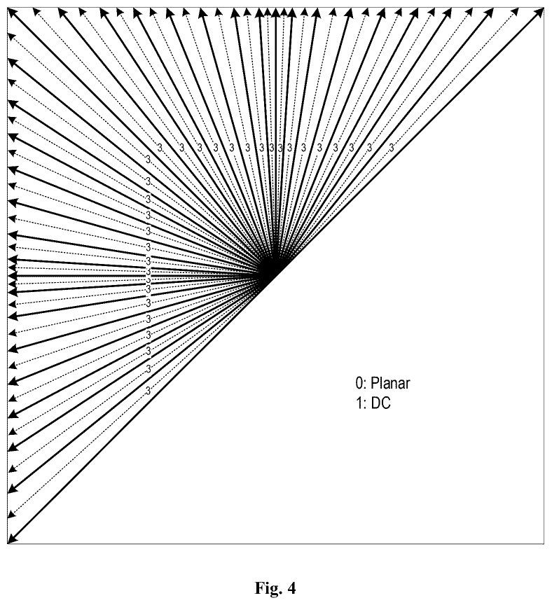

To capture the arbitrary edge directions presented in natural video, the number of directional intra modes in VVC is extended from 33, as used in HEVC, to 65. The new directional modes not in HEVC are depicted as arrows 3 in FIG. 4, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks. Wide angle intra prediction is described in 3.3.1.2.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.1.1.1 Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:

| - | When a neighboring block is not available, its intra mode is set to | |
|---|---|---|
| | Planar by default. | |
| - | If both modes Left and Above are non-angular modes: | |
| | - | MPM list → {Planar, DC, V, H, V − 4, V + 4} |
| - | If one of modes Left and Above is angular mode, and the other is | |
| | non-angular: | |
| | - | Set a mode Max as the larger mode in Left and Above |
| | - | MPM list → {Planar, Max, DC, Max − 1, Max + 1, Max − 2} |
| - | If Left and Above are both angular and they are different: | |
| | - | Set a mode Max as the larger mode in Left and Above |
| | - | if the difference of mode Left and Above is in the range of 2 to 62, |
| | | inclusive |

| | |
|---|---|
| - | MPM list → {Planar, Left, Above, DC, Max − 1, Max + 1} |

| | |
|---|---|
| - | Otherwise |

| | |
|---|---|
| - | MPM list → {Planar, Left, Above, DC, Max − 2, Max + 2} |

| - | If Left and Above are both angular and they are the same: | |
|---|---|---|
| | - | MPM list → {Planar, Left, Left − 1, Left + 1, DC, Left − 2} |

Besides, the first bin of the MPM index codeword is CABAC context coded. In total three contexts are used, corresponding to whether the current intra block is MRL enabled, ISP enabled, or a normal intra block. During 6 MPM list generation process, pruning is used to remove duplicated modes so that only unique modes can be included into the MPM list. For entropy coding of the 61 non-MPM modes, a Truncated Binary Code (TBC) is used.

### 2.1.1.2 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

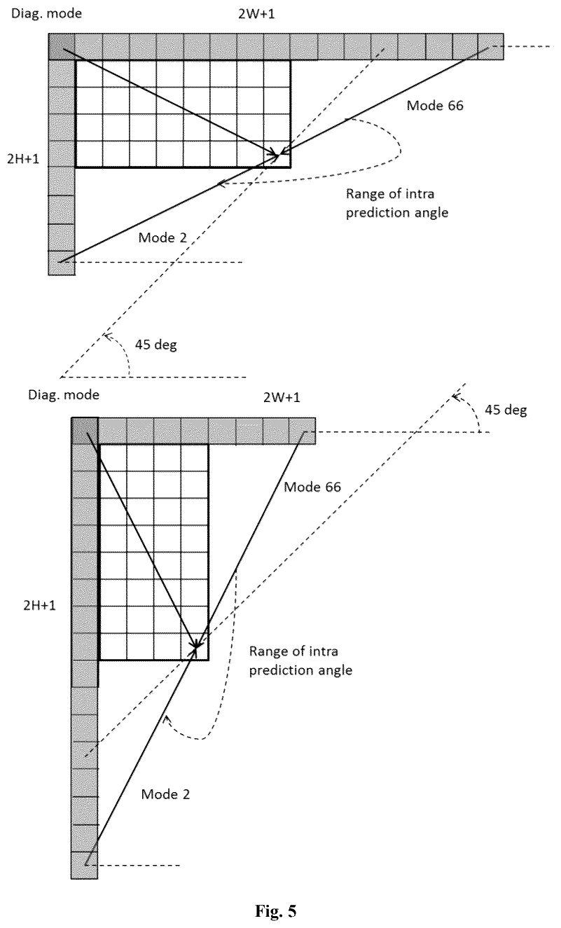

To support these prediction directions, the top reference with length 2W+1, and the left reference with length 2H+1, are defined as shown in FIG. 5.

The number of replaced modes in wide-angular direction mode depends on the aspect ratio of a block. The replaced intra prediction modes are illustrated in Table 2-1.

TABLE 2-1
Intra prediction modes replaced
by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, |
| | 10, 11 |
| W/H == 2 | Modes 2, 3, 4, 5, 6, 7, |
| W/H == 1 | None |
| W/H == 1/2 | Modes 61, 62, 63, 64, 65, 66 |
| W/H == 1/4 | Mode 57, 58, 59, 60, 61, 62, |
| | 63, 64, 65, 66 |
| W/H == 1/8 | Modes 55, 56 |
| W/H == 1/16 | Modes 53, 54, 55, 56 |

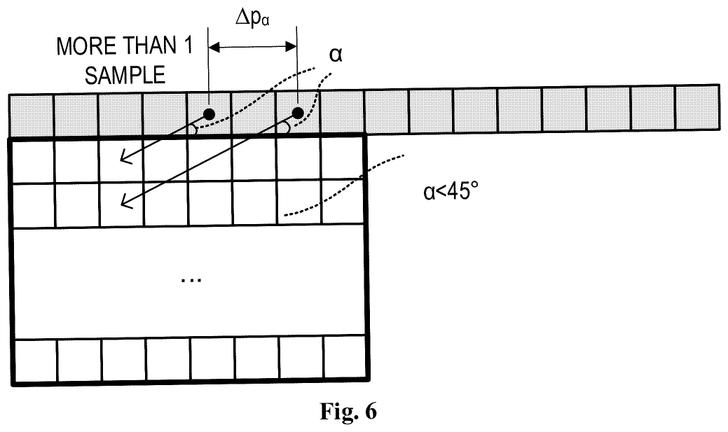

As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Apa. If a wide-angle mode represents a non-fractional offset. There are 8 modes in the wide-angle modes satisfy this condition, which are [−14,−12,−10,−6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes. In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below-135 degree and above 45 degree, luma intra prediction modes ranging from 2 to 5 are mapped to 2. Therefore chroma DM derivation table for 4:2:2:chroma format is updated by replacing some values of the entries of the mapping table to convert prediction angle more precisely for chroma blocks.

### 2.1.1.3 Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66. Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

### 2.1.2 Cross-Component Linear Model Prediction

### 2.1.2.1 Single-Model Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 3 - 1 )$$

where pred_{c}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W. H′=H when LM mode is applied;
W′=W+H when LM-A mode is applied;
H′=H+W when LM-L mode is applied;

The above neighbouring positions are denoted as S [0,−1] . . . . S [W′−1,−1] and the the left neighbouring positions are denoted as S [−1, 0] . . . . S [−1, H′−1]. Then the four samples are selected as
S [W′/4,−1], S [3*W/4,−1], S [−1, H¾], S [−1, 3*H′/4] when LM mode is applied and both above and left neighbouring samples are available;
S [W/8,−1], S [3*W′/8,−1], S [5*W′/8,−1], S [7*W′/8,−1] when LM-A mode is applied or only the above neighbouring samples are available;
S [−1, H′/8], S [−1, 3*H′/8], S [−1, 5*H′/8], S [−1, 7*H′/8] when LM-L mode is applied or only the left neighbouring samples are available;

The four neighbouring luma samples at the selected positions are down-sampled and compared four times to find two smaller values: x°A and x14, and two larger values: x08 and x1 B. Their corresponding chroma sample values are denoted as y°A, y1A, y°B and y18. Then XA, XB, YA and ys are derived as:

$${X}_{a} = ( {x}_{A}^{0} + {x}_{A}^{1} + 1 ) >> 1 ; \qquad ( 3 - 4 )$$

$${X}_{b} = ( {x}_{B}^{0} + {x}_{B}^{1} + 1 ) >> 1 ;$$

$${Y}_{a} = ( {y}_{A}^{0} + {y}_{A}^{1} + 1 ) >> 1 ;$$

$${Y}_{b} = ( {y}_{B}^{0} + {y}_{B}^{1} + 1 ) >> 1$$

Finally, the linear model parameters α and β are obtained according to the following equations.

$$α = \frac{{Y}_{a} - {Y}_{b}}{{X}_{a} - {X}_{b}} \qquad ( 3 - 3 )$$

$$β = {Y}_{b} - α \cdot {X}_{b} \qquad ( 3 - 4 )$$

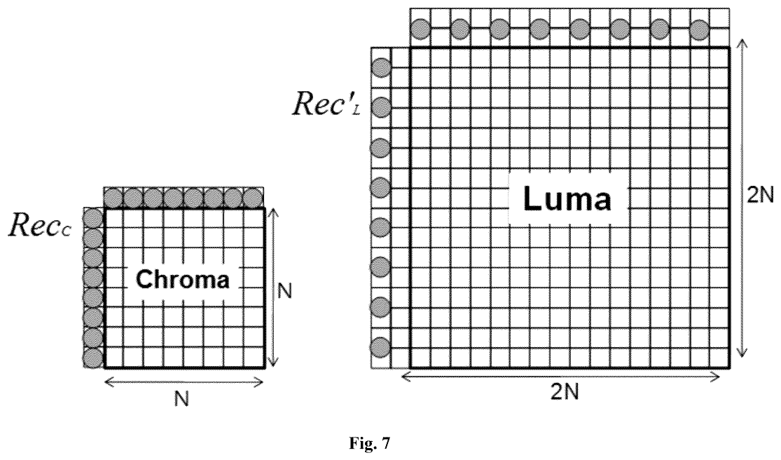

FIG. 7 shows an example of the location of the left and above samples and the sample of the current block involved in the CCLM mode.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 3 - 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template are used to calculate the linear model coefficients. To get more samples, the above template are extended to (W+H). In LM_L mode, only left template are used to calculate the linear model coefficients. To get more samples, the left template are extended to (H+W).

For a non-square block, the above template are extended to W+W, the left template are extended to H+H. To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsmapling filters are as follows, which are corresponding to “type-0” and “type-2” content, respectively.

$${Rec}_{L}^{′} ( \text{} i , \text{} j ) = [ \begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + 2 \cdot \\ {rec}_{L} ( 2 i , 2 j ) + {rec}_{L} ( 2 i + 1 , 2 j ) + 4\end{matrix} ] ≫ 3 \qquad ( 3 - 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot \\ {rec}_{L} ( 2 i , 2 j ) + {rec}_{L} ( 2 i + 1 , 2 j ) + \\ {rec}_{L} ( 2 i , 2 j + 1 ) + 4\end{matrix} ] ≫ 3 \qquad ( 3 - 7 )$$

Note that only one luma line (general line buffer in intra prediction) is used to make the downsampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 3-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 3-3
Derivation of chroma prediction mode
from luma mode when cclm_is enabled

| Chroma | Corresponding luma | | | | |
|---|---|---|---|---|---|
| prediction | intra prediction mode | | | | |
| mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 3-4.

TABLE 3-4
Unified binarization table
for chroma prediction mode

| Value of | |
|---|---|
| intra_chroma_ | Bin |
| pred_mode | string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 3-4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 3-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM;
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.1.2.2 Multi-Model Cross-Component Linear Model Prediction

The above section presents the single-mode cross-component linear model prediction in the VVC specification, which treats all luma and chroma samples of the current coding block and its neighborhood as a whole group, and using a single linear function to modulate the similarities between all those luma and chroma samples. In contrast with single-model that classifies luma and chroma samples into one group, the multi-mode cross-component linear model prediction has been studied by researchers as well. Here “multi-model” is named to indicate a cross-component approach that classify luma and chroma samples into more than one groups and uses more than one functions to modulate the similarities between luma samples and chroma samples of a coding block. For example, for a coding block, it may be coded by a two-model based cross-component prediction, which separates all luma and chroma samples of a coding block into two groups and then each group has one model/function to modulate the similarities between luma and chroma samples belong to this group.

### 3 Problems

The existing designs for cross-component predictions have the following problems:
1) The luma samples should be down-sampled to get the corresponding luma sample value for a chroma sample. The fixed down-sampling filter may not be efficient.

### 4 Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner. In the following discussion, W, and H represent the width and height of the current block, respectively. CCLM may refer to any kinds of CCLM modes, such as CCLM-L, CCLM-T, CCLM-LT, or multi-model CCLM. CCLM may also refer to any other prediction method, which uses the reconstruction samples of a first component to predict at least one sample in a second component, not limited to regular CCLM as defined in JEM or VVC, or CCLM-L, or CCLM-T, or CCLM-LT, or multi-model CCLM.
1. There may be multiple filters to generate a sample value of a first color component (such as Y), corresponding to a sample of a second color component (such as Cb/Cr).
   1) In one example, the multiple filters may be used in the process of CCLM.
   2) In one example, one filter of the multiple filters, denoted as F(Y), wherein {L} represents a set of samples of the first color component, may be derived as F(Y)=(c₀×S₀+c₁×S₁+ . . . . Cₙ×Sₙ+offset)»K, wherein n is the number of taps of F, cᵢ is the filter coefficient of filter tap i, Sᵢ is the value of the i-th sample of the samples of the first component involved in filter F, and offset and K are integers.
      a. Alternatively, at least one non-linear item may be involved in the filter, denoted as F(Y)=(c₀×S₀+c₁×S₁+ . . . . Cₙ×Sₙ+g (S₀, S₁, . . . , Sₙ)+offset)»K, wherein g is a non-linear function. For example, g(S)=log(S) or S² or S³ or S^{w}, or ^{w}\sqrt{S}, etc.
      b. In one example, the filtered result may be clipped.
   3) For example, cᵢ is an integer, which may be positive, negative or zero.
   4) In one example, the sum of cᵢ or |cᵢ| may be a fixed number, such as 2^{K}.
   5) In one example, offset may be equal to 2^{K-1}.
   6) In one example, the positions of samples of the first component involved in filter F may depend on the position of the sample of the second component.
   7) In one example, the positions of samples of the first component involved in filter F may depend on the color format such as 4:4:4 or 4:2:0 or 4:2:2.
   8) For K samples of the second component, filter F will generate K corresponding samples of the first component.
      a. For color format such as 4:2:0 or 4:2:2, filter F may comprise the process of down-sampling or down-scaling when the first component is Y and the second component is Cb or Cr.
   9) Suppose the position of a specific sample in the second component is (xC, yC), and the position of the i-th sample in the first component that is involved in F, which is applied to generate the sample value corresponding to the specific sample, is (xL, yL).
      a. In one example, xL=scaleX*xC+OffX.
      b. In one example, yL=scaleY*yC+OffY.
      c. In one example, scaleX and scaleY may depend on color formats.
         i. For example, scaleX=scaleY=2 for 4:2:0 format.
         ii. For example, scaleX=2, scaleY=1 for 4:2:2 format.
         iii. For example, scaleX=scaleY=1 for 4:4:4 format.
      d. In one example, OffX and OffY are integers, and they may depend on i.
      e. In one example, the samples in the first component that is involved in F corresponding to the specific sample in the second component may be at the positions:
         i. P0:(scaleX*xC, scale Y*yC)
         ii. P1:(scaleX*xC, scale Y*yC+1)
         iii. P2:(scaleX*xC, scale Y*yC−1)
         iv. P3:(scaleX*xC+1, scaleY*yC)
         v. P4:(scaleX*xC+1, scaleY*yC+1)
         vi. P5:(scaleX*xC+1, scaleY*yC−1)
         vii. P6:(scaleX*xC−1, scale Y*yC)
         viii. P7:(scaleX*xC−1, scale Y*yC+1)
         ix. P8:(scaleX*xC−1, scaleY*yC−1).
      f. In one example, the samples in the first component that is involved in F (with 6 taps) corresponding to the specific sample in the second component may be at the positions P0, P1, P3, P4, P6, P7.
      g. In one example, the positions of samples involved in F may depend on the color format.
      h. In one example, the positions of samples involved in F may depend on the first and/or the second color component.
      i. In one example, the positions of samples involved in F may depend on the position of the current block (e.g., whether the current block is at the boundary of a picture/slice/tile/CTU line/CTU).
      j. In one example, the positions of samples involved in F may depend on the type of CCLM, such as regular CCLM, or CCLM-L, or CCLM-T, or CCLM-LT, or multi-model CCLM, etc.
      k. In one example, the filter coefficient of a filter tap at a position may be set to be 0, as an alternative way to remove the tap at the position.
      l. In one example, a sample involved in F may be removed from the filtering process if it is not available (such as out of the current a picture/slice/tile/CTU line/CTU).
      i. In one example, a sample involved in F may be padded from the filtering process if it is not available (such as out of the current a picture/slice/tile/CTU line/CTU).
         a) For example, it may be padded with the value of its nearest available sample.
         a. For example, the nearest available sample must be involved in F.
   10) In one example, a candidate filter set ψ={F₀, F₁, F₂, . . . . F_{M}} may be predefined and at least one of the candidate filter may be used to filter the samples of the first component.
   11) In one example, the coefficients of at least one of filter candidates may be signaled from the encoder to the decoder, such as in SPS/PPS/slice header/picture header/CTU, etc.
      a. The coefficients may be signaled in a predictive way.
      b. A coefficient may be binarized as a fixed-length code//(truncated) unary code/exponential Golomb code/etc.
      c. The coefficients for Cb and Cr may be different and signaled separately for Cb/Cr.
      d. The coefficients for Cb and Cr may be the same and signaled together.
   12) In one example, the coefficients of at least one of filter candidates may be derived on line.
      a. For example, the coefficients may be derived by the least mean square error (LMSE) method using decoded sample values.
      b. The on-line derivation may be conducted for Cb and Cr separately, or may be shared by Cb and Cr.
   13) The candidate filter set may be the same to code different color components such as Cb and Cr.
   14) The candidate filter set may be different to code different color components such as Cb and Cr.
   15) The candidate filter set may depend on coding information, such as coding mode/slice or picture type/W and H/color format/color component/etc.
2. The filter selection may be derived at both the encoder and decoder.
   a. In one example, a cost may be calculated corresponding to a filter and the filter selection may be applied according to the cost of each filter.
      i. For example, the filter with the smallest cost may be selected.
   b. In one example, the cost of a filter F may be derived as the sum of absolute difference (SAD) or sum of squared difference (SSD) or sum of absolute transformed difference (SATD) or mean removal SAD (MR-SAD) of reconstruction samples of the second component at a first set of positions and corresponding prediction values at the first set of positions.
      i. In one example, the first set of positions may include sample positions neighbouring to the current block.
         a) “Neighbouring to” may comprise “left to” and/or “above to” and/or “left-above to” and/or “above-right to” and/or “left-bottom to”.
         b) The first set of sample positions may depend on the availability of neighbouring samples.
         a. For example, the set may only comprise available samples.
         b. For example, the set may comprise samples left to the current block if the left neighbouring block is available.
         ′c. For example, the set may comprise samples above to the current block if the above neighbouring block is available.
      c) The neighbouring samples may be adjacent to the current block or non-adjacent to the current block.
         a. For example, the neighbouring samples may include K rows of samples above the current block.
         b. For example, the neighbouring samples may include K columns of samples left to the current block.
      ii. In one example, prediction values may be derived using the filter F.
         a) In one example, filter F may be used to generate samples (denoted as S) of the first component corresponding to the reconstruction samples (denoted as R) of the second component at a second set of positions.
         b) In one example, S and R may be used to derive one or multiple linear models for filter F.
         a. In one example, the model may be generated using the LMSE method as defined in JEM or the min-max method as defined in VVC.
         b. In one example, multiple models (such as two) may be generated using the method proposed in MMLM.
      c) In one example, the one or multiple linear models may be applied to generate the prediction value of a sample of the second component at position (x, y) in the first set as
         a. P(x, y)=a*S(x,y)+b, wherein P(x,y) is the prediction value and S(x,y) is the corresponding luma sample. (a, b) represents the linear model.
         b. For example, extra operations such as shifting or clipping may be applied to derive the prediction value with the linear model.
         d) In one example, whether to derive/use one model or multiple models may depend on the coding mode.
         a. For example, when CCLM mode is applied, one mode is derived/used to generate prediction values.
         b. For example, when MMLM mode is applied, one mode is derived/used to generate prediction values.
      iii. The first set of the positions and the second set of positions may be the same.
      iv. The first set of the positions and the second set of positions may be different.
         a) In one example, the first set of the positions may comprise two rows of samples above the current block and/or two columns of samples left to the current block.
         b) In one example, the second set of the positions may comprise one row of samples above the current block and/or one column of samples left to the current block.
      v. The first set of the positions and/or the second set of positions may depend on the coding mode.
         a) For example, the first set of the positions and/or the second set of positions may only comprise samples left to the current block if the current coding mode is CCLM-L.
         b) For example, the first set of the positions and/or the second set of positions may only comprise samples above to the current block if the current coding mode is CCLM-T.
3. The filter selection information may be signaled from the encoder to the decoder.
   a. In one example, a syntax element SE (such as a filter index) may be signaled in CU/TU/PU/CTU/slice/picture to indicate the selected filter.
      i. SE may be coded with at least one coding context in arithmetic coding.
      ii. SE may be coded with bypass coding.
      iii. SE may be binarized as a fixed-length code/(truncated) unary code/exponential Golomb code/etc.
      iv. SE may be coded in a predictive way, such as predicted by the SE from at least one neighbouring block.
      v. For example, SE may be signaled individually for at least two components, such as Cb and Cr. i.e., the two components such as Cb and Cr may have different SEs.
      vi. For example, X_flag may be signaled once for at least two components, such as Cb and Cr. i.e., the two components such as Cb and Cr may have the same SE.
4. In one example, multi-stage filters may be applied.
   a. In one example, samples (denoted as S) of the first component may be filtered by a first filter (denoted as F₁) to generate filtered samples (denoted as S′). And S′ may be filtered by a second filter (denoted as F₂) to generate filtered samples S″
      i. In one example, S″ may be used in the process of CCLM as the samples of the first component corresponding to samples in the second component.
      ii. In one example, S″ may be further filtered by a third filter (denoted as F3) to generate filtered sample S″″
         a) S′″ may be used in the process of CCLM as the samples of the first component corresponding to samples in the second component.
         b) S′″ may be further filtered.
   b. If the color format is not 4:4:4, i.e., the resolution of the first component and that of the second component are different, the re-sampling (e.g. down-sampling) process may associated with any stage of the filters.
   c. In one example, the samples in S(n) that is involved in the n-th filtering stage may be at the positions:
      i. P0:(scaleX⁽ⁿ⁾*xC, scaleY⁽ⁿ⁾*yC)
      ii. P1:(scaleX⁽ⁿ⁾*xC, scaleY⁽ⁿ⁾*yC+1)
      iii. P2:(scaleX⁽ⁿ⁾*xC, scaleY⁽ⁿ⁾*yC−1)
      iv. P3:(scaleX⁽ⁿ⁾*xC+1, scaleY⁽ⁿ⁾*yC)
      v. P4:(scaleX⁽ⁿ⁾*xC+1, scaleY⁽ⁿ⁾*yC+1)
      vi. P5:(scaleX⁽ⁿ⁾*xC+1, scaleY⁽ⁿ⁾*yC−1)
      vii. P6:(scaleX⁽ⁿ⁾*xC−1, scaleY⁽ⁿ⁾*yC)
      viii. P7:(scaleX⁽ⁿ⁾*xC−1, scaleY⁽ⁿ⁾*yC+1)
      ix. P8:(scaleX⁽ⁿ⁾*xC−1, scaleY⁽ⁿ⁾*yC−1)
      wherein scaleX⁽ⁿ⁾and scaleY⁽ⁿ⁾ denotes the scaling ratio of the samples before the n-th filtering and the samples of the second component. For example, if the samples before the n-th filtering and the samples of the second component have the same resolution, scaleX (n)=scale Y (n)=1.
   d. In one example, the filter in one stage (such as the first stage) may be fixed.
   e. In one example, the filter in one stage (such as the second stage) may be adaptive.
      i. For example, the filter may be selected from a set of candidate filters.
      ii. For example, the filter may be derived on-line.
      iii. For example, the filter may be signaled from encoder to decoder.
   f. In one example, a two-stage filtering is applied.
      i. In the first stage, the luma sample are filtered and down-sampled with the filtering method defined in VVC, i.e. corresponding to a position (i, j) of the chroma component when the color format is 4:2:0. we have

$${S}^{′} ( i , j ) = [ \begin{matrix}S ( 2 i - 1 , 2 j - 1 ) + 2 \cdot S ( 2 i - 1 , 2 j - 1 ) + \\ S ( 2 i + 1 , 2 j - 1 ) + S ( 2 i - 1 , 2 j ) + 2 \cdot \\ S ( 2 i , 2 j ) + S ( 2 i + 1 , 2 j ) + 4\end{matrix} ] ≫ 3$$

ii. In the second stage, S′ are further filtered adaptively.
g. In one example, any method on filters disclosed in this document can be applied to a filter in any stage of the multiple-stage filtering.
5. In one example, when Luma Mapping with Chroma Scaling (LMCS) is applied, the samples of the first component to be filtered may be in the original domain, or they be in the converted (mapped) domain.
6. In one example, samples of the first component may be filtered in different ways, when it is used in the in the process of CCLM as the samples of the first component corresponding to samples in different components.
   a. For example, a first filter (denoted as F₁) may be applied on a second component such as Cb, while a second filter (denoted as F₂) may be applied on a third component such as Cr.
      i. In one example, the derivation process of the filter may be performed individually for Cb component and Cr component.
      ii. In one example, the filter index may be signaled individually for Cb component and Cr component.
7. In one example, samples of the first component may be filtered in the same way, when it is used in the in the process of CCLM as the samples of the first component corresponding to samples in different components.
   a. For example, a first filter (denoted as F₁) may be applied on a second component such as Cb, while the first filter F₁ may also be applied on a third component such as Cr.
      i. In one example, the derivation process of the filter may be performed once for both Cb component and Cr component.
         a) In one example, the derivation may depend on samples of one of the two components, such as Cb.
         b) In one example, the derivation may depend on samples of both the two components.
      ii. In one example, the filter index may be signaled once for both Cb component and Cr component.
8. A coding mode X may be applied, with the multi-filter approach for cross-component prediction.
   a. In one example, whether the coding mode X is allowed or not may be signaled from the encoder to the decoder, such as in SPS/PPS/picture header/slice header/CTU line/CTU/CU etc.
   b. In one example, whether the coding mode X is allowed or not may depend on coding information.
      i. For example, coding mode X is allowed (only) if a specific mode is applied, such as regular CCLM and/or CCLM-L and/or CCLM-T and/or CCLM-LT and/or multi-model CCLM.
      ii. For example, coding mode X is allowed (only) if W and/or H satisfy one or more conditions, such as: W*H<=T1 and/or W*H>=T2 and/or max (W, H)<=T3, and/or min (W, H)>=T4.
         a) For example, coding mode X is allowed only if W*H>8;
      iii. For example, coding mode X is allowed (only) for a specific kind of slice/picture type, such as I-Slice.
      iv. For example, coding mode X is allowed (only) for a specific kind color format such as 4:2:0.
      v. For example, coding mode X is allowed (only) for a specific color component such as Cb and/or Cr.
      vi. For example, coding mode X is allowed (only) for a specific profile/level of a standard.
      vii. For example, coding mode X is allowed (only) if at least K neighboring samples are available. (e.g K=1, 2, 3, 4 . . . ).
   c. In one example, whether a syntax element X_flag may be signaled to indicate whether coding mode X is used.
      i. For example, X_flag is signaled only if mode X is allowed.
      ii. For example, X_flag is set to a default value (such as 0 meaning mode X is not used) if mode X is not allowed.
      iii. For example, X_flag may be signaled for a picture or a slice or a CTU or a CU or a PU or a TU.
      iv. For example, X_flag may be signaled individually for at least two components, such as Cb and Cr. i.e., the two components such as Cb and Cr may have different X_flags and they are handled differently on whether to perform multi-filter approach.
      v. For example, X_flag may be signaled once for at least two components, such as Cb and Cr. i.e., the two components such as Cb and Cr may have the same X_flag and they are handled in the same way on whether to perform multi-filter approach.
      vi. X_flag may be coded with at least one coding context in arithmetic coding.
      vii. X_flag may be coded with bypass coding.
   d. In one example, a second syntax element related to the multi-filter approach for cross-component prediction may be signaled after X_flag.
      i. In one example, the second syntax element may be signaled only if the multi-filter approach is indicated to be applied.
      ii. In one example, the second syntax element may indicate the filter to be used.
      iii. In one example, the second syntax element may indicate the method to derive the filter.

### General Aspects

9. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
10. Whether to and/or how to apply the disclosed methods above may be signalled at PB/TB/CB/PU/TU/CU/VPDU/CTU/CTU row/slice/tile/sub-picture/other kinds of region contain more than one sample or pixel.
11. Whether to and/or how to apply the disclosed methods above may be dependent on coded information, such as block size, colour format, single/dual tree partitioning, colour component, slice/picture type.

### 5 EMBODIMENTS

### 5.1 Embodiment 1

A self-aware filter estimation CCLM (SAFE-CCLM) method is proposed to explore the advantage of multiple down-sampling filters without signaling the filter index.

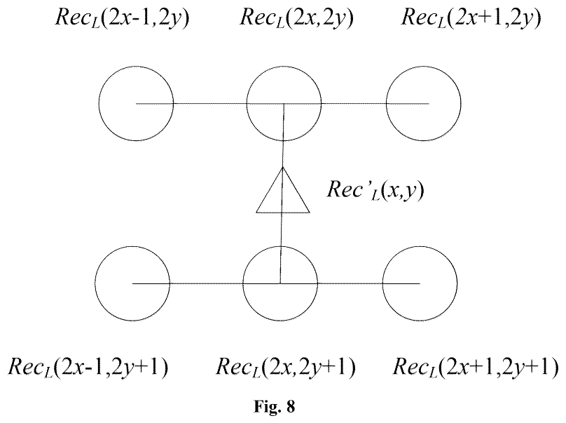

With SAFE-CCLM, N candidate luma down-sampling filters are predefined. As shown in FIG. 8, the down-sampling filtering process for 4:2:0 color format is performed as

$${Rec}_{L}^{′} ( x , y ) = \{ {c}_{0} {Rec}_{L} ( 2 x - 1 , 2 y ) + {c}_{1} {Rec}_{L} ( 2 x , 2 y ) + {c}_{2} {Rec}_{L} ( 2 x + 1 , 2 y ) + {c}_{3} {Rec}_{L} ( 2 x - 1 , 2 y + 1 ) + {c}_{4} {Rec}_{L} ( 2 x , 2 y + 1 ) + {c}_{5} {Rec}_{L} ( 2 x + 1 , 2 y + 1 ) + 4 \} ≫ 3 ,$$

where Rec_{L}(x, y) and Rec′_{L}(x, y) are reconstructed luma samples before and after the down-sampling filtering at position (x, y), and {c₀, c₁, c₂, c₃, c₄, c₅} are filtering coefficients. It should be noted that {c₀, c₁, c₂, c₃, c₄, c₅}={1, 2, 1, 1, 2, 1} in the current ECM. N candidate luma sampling filter with different coefficients are predefined by SAFE-CCLM.

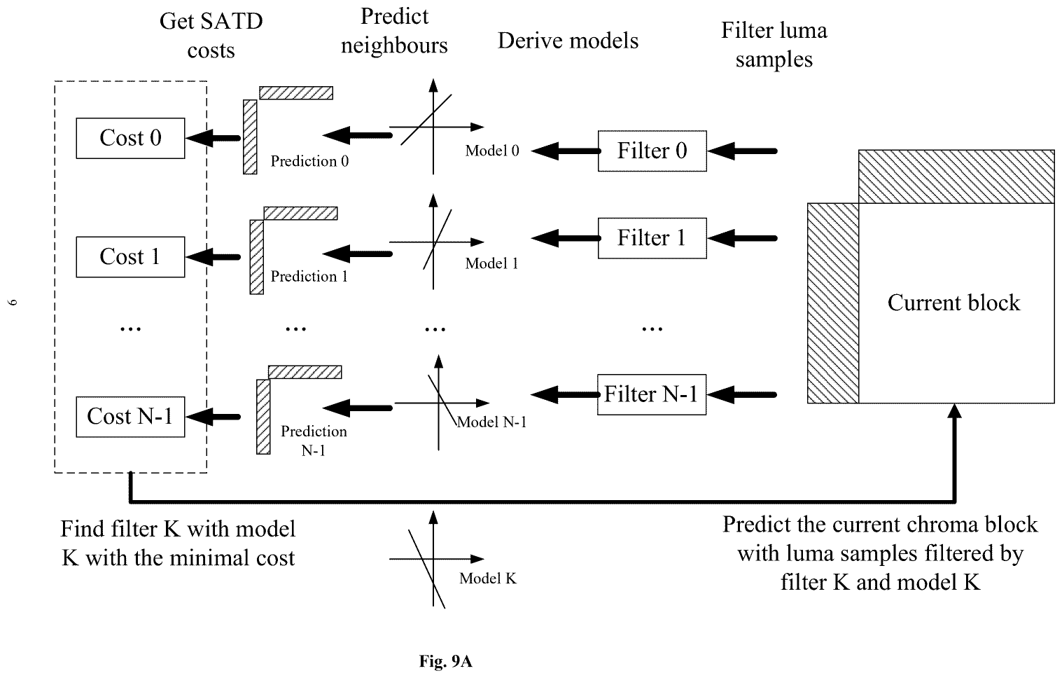

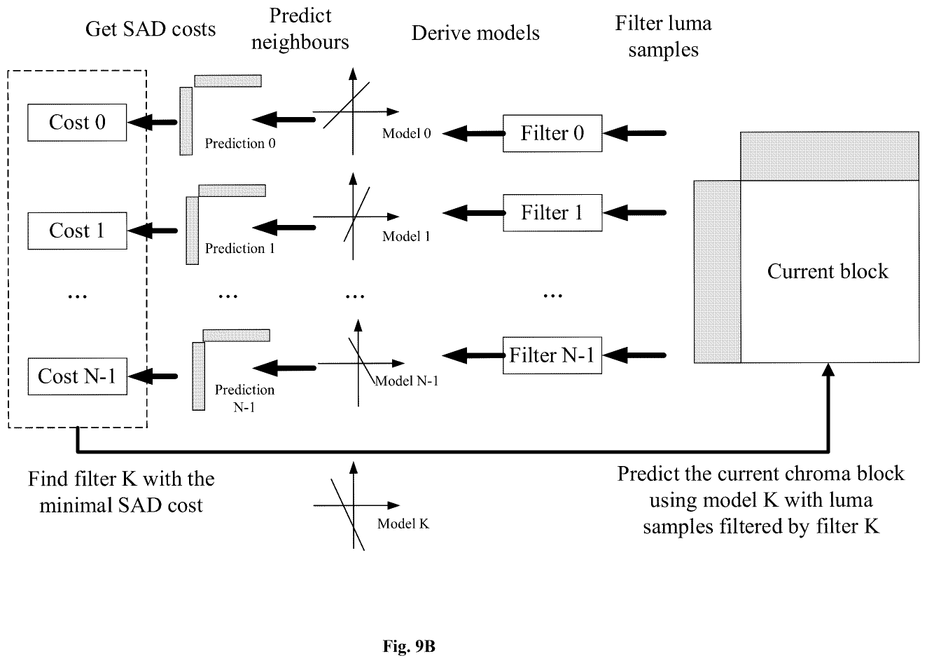

FIG. 9A and FIG. 9B show flow charts of SAFE-CCLM. First, when SAFE-CCLM is applied, a linear model between luma and chroma component is derived in the same way as that in ECM for each candidate filter, respectively. Second, prediction values are calculated on a testing region including the one-column left neighbouring samples and one-row above neighbouring samples with the linear model. Third, a SAD cost between the reconstructed chroma samples and their corresponding prediction values is computed for each filter candidate. Finally, the filter candidate with the least SAD cost is selected as the down-sampling filter to perform the CCLM prediction for the current block.

When CCLM is indicated to be used for a block, a SAFE-CCLM flag is signaled to further indicate whether SAFE-CCLM is applied.

In this embodiment. N=32. and the filter candidate set is as below.

| F1 | F2 | F3 | F4 | F5 | F6 | F7 | F8 |
|---|---|---|---|---|---|---|---|
| $\frac{1}{4} [ \begin{matrix}0 & 1 & 1 \\ 0 & 1 & 1\end{matrix} ]$ | $\frac{1}{2} [ \begin{matrix}0 & 1 & 1 \\ 0 & 0 & 0\end{matrix} ]$ | $\frac{1}{2} [ \begin{matrix}0 & 0 & 1 \\ 0 & 0 & 1\end{matrix} ]$ | $\frac{1}{2} [ \begin{matrix}0 & 1 & 0 \\ 0 & 1 & 0\end{matrix} ]$ | $\frac{1}{2} [ \begin{matrix}0 & 1 \\ 0 & 1\end{matrix} \text{?}$ | $\frac{1}{4} [ \begin{matrix}1 & 2 \\ - 1 & - 2\end{matrix} \text{?}$ | $\frac{1}{2} [ \begin{matrix}0 & 1 \\ 0 & - 1\end{matrix} \text{?}$ | $\frac{1}{2} [ \begin{matrix}0 & 0 & 1 \\ 0 & 0 & - 1\end{matrix} ]$ |
| F9 | F10 | F11 | F12 | F13 | F14 | F15 | F16 |
| $[ \begin{matrix}0 & 1 & 0 \\ 0 & 0 & 0\end{matrix} ]$ | $[ \begin{matrix}0 & 0 & 1 \\ 0 & 0 & 0\end{matrix} ]$ | $[ \begin{matrix}0 & 0 & 0 \\ 0 & 1 & 0\end{matrix} ]$ | $[ \begin{matrix}0 & 0 & 0 \\ 0 & 0 & 1\end{matrix} ]$ | $[ \begin{matrix}1 & 0 & 0 \\ 0 & 0 & 0\end{matrix} ]$ | $[ \begin{matrix}0 & 0 & 0 \\ 1 & 0 & 0\end{matrix} ]$ | $\frac{1}{4} [ \begin{matrix}1 & 2 & 1 \\ 0 & 0 & 0\end{matrix} \text{?}$ | $\frac{1}{4} [ \begin{matrix}0 & 0 & 0 \\ 1 & 2 & 1\end{matrix} ]$ |
| F17 | F18 | F19 | F20 | F21 | F22 | F23 | F24 |
| $\frac{1}{2} [ \begin{matrix}- 1 & 1 & 0 \\ - 1 & 1 & 0\end{matrix} ]$ | $\frac{1}{2} [ \begin{matrix}- 1 & 0 & 1 \\ - 1 & 0 & 1\end{matrix} \text{?}$ | $\frac{1}{2} [ \begin{matrix}0 & 1 & - 1 \\ 0 & 1 & - 1\end{matrix} \text{?}$ | $\frac{1}{4} [ \begin{matrix}3 & 6 \\ - 1 & - 2\end{matrix} \text{?}$ | $\frac{1}{2} [ \begin{matrix}0 & 1 & 0 \\ 0 & 0 & - 1\end{matrix} \text{?}$ | $\frac{1}{2} [ \begin{matrix}0 & 0 & 1 \\ 0 & - 1 & 0\end{matrix} ]$ | $\frac{1}{2} [ \begin{matrix}0 & 1 \\ - 1 & 0\end{matrix} \text{?}$ | $\frac{1}{2} [ \begin{matrix}1 & 0 & 0 \\ 0 & - 1 & 0\end{matrix} ]$ |
| F25 | F26 | F27 | F28 | F29 | F30 | F31 | F32 |
| $[ \begin{matrix}- 1 & 2 & - 1 \\ - 1 & 2 & - 1\end{matrix} ]$ | $[ \begin{matrix}0 & 0 & 1 \\ - 1 & 0 & 0\end{matrix} ]$ | $[ \begin{matrix}1 & 0 & 0 \\ 0 & 0 & - 1\end{matrix} ]$ | $\frac{1}{4} [ \begin{matrix}1 & 0 & 1 \\ 1 & 0 & 1\end{matrix} ]$ | $[ \begin{matrix}1 & 1 & 0 \\ 1 & - 1 & 0\end{matrix} ]$ | $[ \begin{matrix}0 & 1 & 1 \\ 0 & - 1 & 1\end{matrix} ]$ | $[ \begin{matrix}1 & 0 & 1 \\ 0 & 1 & 0\end{matrix} ]$ | $[ \begin{matrix}0 & 1 & 0 \\ 1 & 0 & 1\end{matrix} ]$ |

or

| F0 | F1 | F2 | F3 | F4 | F5 | F6 | F7 |
|---|---|---|---|---|---|---|---|
| $\frac{1}{4} [ \begin{matrix}0 & 1 & 1 \\ 0 & 1 & 1\end{matrix} ]$ | $\frac{1}{2} [ \begin{matrix}0 & 1 & 1 \\ 0 & 0 & 0\end{matrix} ]$ | $\frac{1}{2} [ \begin{matrix}0 & 0 & 1 \\ 0 & 0 & 1\end{matrix} ]$ | $\frac{1}{2} [ \begin{matrix}0 & 1 & 0 \\ 0 & 1 & 0\end{matrix} ]$ | $\frac{1}{2} [ \begin{matrix}0 & 1 & - 1 \\ 0 & 1 & - 1\end{matrix} \text{?}$ | $\frac{1}{4} [ \begin{matrix}1 & 2 \\ - 1 & - 2\end{matrix} \text{?}$ | $\frac{1}{2} [ \begin{matrix}0 & 1 \\ 0 & - 1\end{matrix} \text{?}$ | $\frac{1}{2} [ \begin{matrix}0 & 0 & 1 \\ 0 & 0 & - 1\end{matrix} ]$ |
| F8 | F9 | F10 | F11 | F12 | F13 | F14 | F15 |
| $[ \begin{matrix}0 & 1 & 0 \\ 0 & 0 & 0\end{matrix} ]$ | $[ \begin{matrix}0 & 0 & 1 \\ 0 & 0 & 0\end{matrix} ]$ | $[ \begin{matrix}0 & 0 & 0 \\ 0 & 1 & 0\end{matrix} ]$ | $[ \begin{matrix}0 & 0 & 0 \\ 0 & 0 & 1\end{matrix} ]$ | $[ \begin{matrix}1 & 0 & 0 \\ 0 & 0 & 0\end{matrix} ]$ | $[ \begin{matrix}0 & 0 & 0 \\ 1 & 0 & 0\end{matrix} ]$ | $\frac{1}{4} [ \begin{matrix}1 & 2 & 1 \\ 0 & 0 & 0\end{matrix} ]$ | $\frac{1}{4} [ \begin{matrix}0 & 0 & 0 \\ 1 & 2 & 1\end{matrix} ]$ |
| F16 | F17 | F18 | F19 | F20 | F21 | F22 | F23 |
| $\frac{1}{2} [ \begin{matrix}- 1 & 1 & 0 \\ - 1 & 1 & 0\end{matrix} ]$ | $\frac{1}{2} [ \begin{matrix}- 1 & 0 & 1 \\ - 1 & 0 & 1\end{matrix} \text{?}$ | $\frac{1}{2} [ \begin{matrix}0 & 1 & - 1 \\ 0 & 1 & - 1\end{matrix} \text{?}$ | $\frac{1}{4} [ \begin{matrix}3 & 6 \\ - 1 & - 2\end{matrix} \text{?}$ | $\frac{1}{2} [ \begin{matrix}0 & 1 & 0 \\ 0 & 0 & - 1\end{matrix} \text{?}$ | $\frac{1}{2} [ \begin{matrix}0 & 0 & 1 \\ 0 & - 1 & 0\end{matrix} ]$ | $\frac{1}{2} [ \begin{matrix}0 & 1 \\ - 1 & 0\end{matrix} \text{?}$ | $\frac{1}{2} [ \begin{matrix}1 & 0 & 0 \\ 0 & - 1 & 0\end{matrix} ]$ |
| F24 | F25 | F26 | F27 | F28 | F29 | F30 | F31 |
| $[ \begin{matrix}- 1 & 2 & - 1 \\ - 1 & 2 & - 1\end{matrix} ]$ | $[ \begin{matrix}0 & 0 & 1 \\ - 1 & 0 & 0\end{matrix} ]$ | $[ \begin{matrix}1 & 0 & 0 \\ 0 & 0 & - 1\end{matrix} ]$ | $\frac{1}{4} [ \begin{matrix}1 & 0 & 1 \\ 1 & 0 & 1\end{matrix} ]$ | $[ \begin{matrix}1 & 1 & 0 \\ 1 & - 1 & 0\end{matrix} ]$ | $[ \begin{matrix}0 & 1 & 1 \\ 0 & - 1 & 1\end{matrix} ]$ | $[ \begin{matrix}1 & 0 & 1 \\ 0 & 1 & 0\end{matrix} ]$ | $[ \begin{matrix}0 & 1 & 0 \\ 1 & 0 & 1\end{matrix} ]$ |

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “wrap around motion compensation (WAMC)” used herein may refer to a coding method when a motion vector refers to samples beyond one or more picture boundaries of the reference picture, instead of padding the boundaries (e.g., repetitive padding, mirrored padding, motion compensation padding, or other padding methods) to derive the values of the out-of-bounds samples, the motion vector is adjusted inside the picture with one or more wrap-around offsets.

In the following discussion, W, and H represent the width and height of the current block, respectively. The term “CCLM” used herein may refer to any kinds of CCLM modes, such as CCLM-L, CCLM-T, CCLM-LT, or multi-model CCLM. The term “CCLM” used herein may also refer to any other prediction method, which uses the reconstruction samples of a first component to predict at least one sample in a second component, not limited to regular CCLM as defined in JEM or VVC, or CCLM-L, or CCLM-T, or CCLM-LT, or multi-model CCLM.

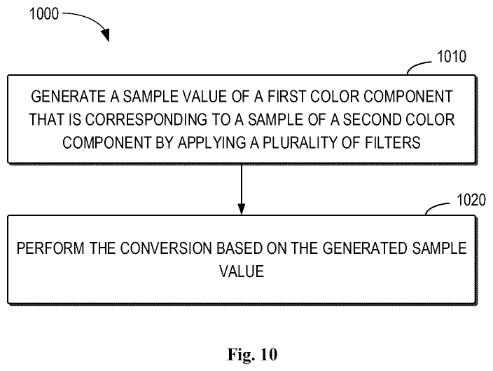

FIG. 10 illustrates a flowchart of a method 1000 for video processing in accordance with embodiments of the present disclosure. The method 4700 is implemented during a conversion between a video unit of a video and a bitstream of the video.

At block 1010, for a conversion between a video unit of a video and a bitstream of the video unit, a sample value of a first color component of the video unit that is corresponding to a sample of a second color component is generated by applying a plurality of filters to at least one sample of the first color component. In some embodiments, the plurality of filters is applied in a process of cross-component linear model prediction of the video unit.

At block 1020, the conversion is performed based on the generated sample value. In some embodiments, the conversion may include encoding the video unit into the bitstream. Alternatively, or in addition, the conversion may include decoding the video unit from the bitstream. In this way, coding efficiency and coding performance can be improved.

In some embodiments, a target filter of the plurality of filters is derived as: F(Y)=(c₀×S₀+c₁×S₁+ . . . . Cₙ×Sₙ+offset)»K, and where F(Y) represents the target filter, {Y} represents a set of samples of the first color component, n represents the number of taps of the target filter, cᵢ represents a filter coefficient of filter tap i, Sᵢ represents a value of the i-th sample of the first color component involved in represents, i is an integer and offset and K are integers respectively. In some embodiments, at least one non-linear item involved in a target filter of the plurality of filters is denoted as: F(Y)=(c₀×S₀+Cₙ×S₁+ . . . . Cₙ×Sₙ+g (S₀, S₁, . . . , Sₙ)+offset)»K, and where F(Y) represents the target filter, {Y} represents a set of samples of the first color component, n represents the number of taps of the target filter, cᵢ represents a filter coefficient of filter tap i, Sᵢ represents a value of the i-th sample of the first color component involved in represents, and offset and K are integers respectively, g represents a non-linear function. In some embodiments, g(S) is one of: log(S) or S² or S³ or S^{w}, or

$$\sqrt[W]{S} ,$$

and where w is an integer. In some embodiments, a filtered result after the plurality of filters is clipped.

In some embodiments, the filter coefficient of filter tap is an integer, and the filter coefficient of filter tap is positive, negative or zero. In some embodiments, a sum of cᵢ or |cᵢ| is a fixed number, where cᵢ represents the filter coefficient of filter tap i.

In some embodiments, the sum is 2^{K}, where K is an integer. In some embodiments, the offset is equal to 2^{K-1}, where K is an integer.

In some embodiments, positions of samples of the first color component involved in a target filter of the plurality of filters depends on a position of the sample of the second color component. In some embodiments, positions of samples of the first color component involved in a target filter of the plurality of filters depends on a color format. In some embodiments, the color format is one of: 4:4:4 or 4:2:0 or 4:2:2.

In some embodiments, for K samples of the second color component, a target filter in the plurality of filters generates K corresponding samples of the first color component, where K is an integer. In some embodiments, for color format being 4:2:0 or 4:2:2, the target filter comprises a process of down-sampling or down-scaling when the first color component is Y and the second color component is Cb or Cr.

In some embodiments, xL=scaleX*xC+OffX, and/or yL=scaleY*yC+OffY, and where xC, yC represent a position of a specific sample in the second color component, xL, yL represent a position of the i-th sample in the first color component involved in a target filer of the plurality of filter corresponding to the specific sample, and scaleX and scaleY are scale factors, respectively. In some embodiments, scaleX and scaleY depends on a color format. In some embodiments, for the color format being 4:2:0, scaleX and scale Y equal to 2, or for the color format being 4:2:2, scaleX equal to 2 and scaleY equals to 1, or for the color format being 4:4:4, scaleX and scaleY equal to 1.

In some embodiments, OffX and OffY depend on a sequence value (i) of the sample and are integers. In some embodiments, samples in the first color component that is involved in the target filter corresponding to the specific sample in the second color component are at one or more of the following positions: P0:(scaleX *xC, scaleY*yC), P1:(scaleX*xC, scaleY*yC+1), P2:(scaleX*xC, scaleY*yC−1), P3: (scaleX*xC+1, scaleY*yC), P4:(scaleX*xC+1, scaleY*yC+1), P5:(scaleX*xC+1, scaleY*yC−1), P6:(scaleX*xC−1, scaleY*yC), P7:(scaleX*xC−1, scaleY*yC+1), and P8:(scaleX*xC−1, scaleY*yC−1), and where P0, P1, P2, P3, P4, P5, P6, P7 and P8 represent the positions, xC, yC represent a position of a specific sample in the second color component, xL, yL represent a position of the i-th sample in the first color component involved in a target filer of the plurality of filter corresponding to the specific sample, and scaleX and scaleY are scale factors, respectively.

In some embodiments, the samples in the first color component that is involved the target filter with 6 taps corresponding to the specific sample in the second color component are at the positions P0, P1, P3, P4, P6, P7. In some embodiments, positions of samples involved in the target filter depends on a color format. In some embodiments, positions of samples involved in the target filter depends on at least one of: the first or the second color component. In some embodiments, positions of samples involved in the target filter depends on a position of a current block.

In some embodiments, the position of the current block is at a boundary of one of: a picture, a slice, tile, a coding tree unit (CTU), or a CTU line. In some embodiments, positions of samples involved in the target filter depends on a type of cross component linear model (CCLM) of the video unit. In some embodiments, the type of CCLM comprises at oner of: a regular CCLM, a CCLM-L, a CCLM-T, a CCLM-LT, or a multi-model CCLM.

In some embodiments, a filter coefficient of a filter tap at a position is set to be 0, to remove the filter tap at the position. In some embodiments, a sample involved in the target filter is removed from a filtering process if the sample is not available (such as out of the current a picture/slice/tile/CTU line/CTU).

In some embodiments, the sample involved in the target filter is padded from a filtering process if the sample is not available (such as out of the current a picture/slice/tile/CTU line/CTU). In some embodiments, the sample is padded with a value of a nearest available sample of the sample. In some embodiments, the nearest available sample is involved in the target filter.

In some embodiments, a candidate filter set (for example, Y={F₀, F₁, F₂, . . . . F_{M}}) is predefined and at least one candidate filter from the candidate filter set is used to filter samples of the first color component. In some embodiments, coefficients of the at least one of filter candidate are indicated from an encoder to a decoder, for example, in SPS/PPS/slice header/picture header/CTU, etc.

In some embodiments, the coefficients are indicated in a predictive way. In some embodiments, a coefficient is binarized as one of: a fixed-length code, a unary code, a truncated unary code, or an exponential Golomb code. In some embodiments, the coefficients for Cb and Cr are different and separately indicated. In some embodiments, the coefficients for Cb and Cr are same and indicated together.

In some embodiments, coefficients of the at least one of filter candidate are derived on-line. For example, the coefficients are derived by a least mean square error (LMSE) method using decoded sample values. In some embodiments, the on-line derivation of the coefficients is conducted for Cb and Cr separately, or the on-line derivation of the coefficients is shared by Cb and Cr.

In some embodiments, the candidate filter set is the same to code different color components. In some embodiments, the candidate filter set is different to code different color components.

In some embodiments, the candidate filter set depends on coding information of the video unit. For example, the coding information comprises at least one of: a coding mode, a slice type, a picture type, a width of the video unit, a height of the video unit, a color format of the video unit or a color component of the video unit.

In some embodiments, filter selection information regarding the plurality of filters is indicated from an encoder to a decoder. In some embodiments, a syntax element (such as, a filter index) is indicated in one of the followings to indicate a selected filter: a coding unit (CU), a prediction unit (PU), a transform unit (TU), a CTU, a slice, or a picture.

In some embodiments, the syntax element is coded with at least one coding context in arithmetic coding. In some embodiments, the syntax element is coded with bypass coding. In some embodiments, the syntax element is binarized as one of: a fixed-length code, a unary code, a truncated unary code, or an exponential Golomb code. In some embodiments, the syntax element is coded in a predictive way. In some embodiments, the syntax element is individually for at least two components. In some embodiments, the syntax element is indicated for at least two components.

In some embodiments, the method further comprises determining whether a coding mode is applied during a multi-filter approach for a cross-component prediction of the video unit. In some embodiments, whether the coding mode is allowed or not is indicated from an encoder to a decoder in one of the following: a sequence parameter set (SPS), a picture parameter set (PPS), a picture header, a slice headers, a CTU line, a CTU, or a CU.

In some embodiments, whether the coding mode is allowed or not depends on coding information. In some embodiments, the coding mode is allowed if a specific mode is applied to the video unit. In some embodiments, the specific mode comprises at least one of: a regular CCLM, a CCLM-L, a CCLM-T, a CCLM-LT, or a multi-model CCLM. 58.

In some embodiments, the coding mode is allowed, if a width of the video unit and a height of the video unit satisfies one or more conditions. In some embodiments, the one or more conditions comprises at least one of: W*H<=T1, W*H>=T2, max (W, H)<=T3, min (W, H)>=T4, or W*H is larger than a predetermined number, and where W represents the width of the video unit, H represents the height of the video unit, T1, T2, T3 and T4 are integer numbers.

In some embodiments, the coding mode X is allowed for a specific kind of slice type or a picture type (for example, I-Slice). In some embodiments, the coding mode is allowed for a specific kind color format. In some embodiments, the coding mode is allowed for a specific color component. In some embodiments, the coding mode is allowed for a specific profile or level of a standard. In some embodiments, the coding mode is allowed if at least K neighboring samples are available, where K is an integer number, for example, 1, 2,3,4 and the like.

In some embodiments, whether a syntax element (for example X_flag) is indicated depends on whether the coding mode is applied. In some embodiments, the syntax element is indicated if the coding mode is allowed. In some embodiments, the syntax element is set to a default value (such as 0 meaning the coding mode is not used) if the coding mode is not allowed. In some embodiments, the syntax element is indicated for one of: a picture, a slice, a CTU, a CU, a PU, or a TU.

In some embodiments, the syntax element is indicated individually for at least two components, and the at least two components are handled differently on whether to perform the multi-filter approach. For example, X_flag may be signaled individually for at least two components, such as Cb and Cr. i.e., the two components such as Cb and Cr may have different X_flags and they are handled differently on whether to perform multi-filter approach.

In some embodiments, the syntax element is indicated for at least two components, and the at least two components are handled in the same way on whether to perform the multi-filter approach. For example, X_flag may be signaled once for at least two components, such as Cb and Cr. i.e., the two components such as Cb and Cr may have the same X_flag and they are handled in the same way on whether to perform multi-filter approach.

In some embodiments, the syntax element is coded with at least one coding context in arithmetic coding. In some embodiments, the syntax element is coded with bypass coding.

In some embodiments, a further syntax element related to the multi-filter approach for the cross-component prediction is indicated after the syntax element. In some embodiments, the further syntax element is indicated only if the multi-filter approach is indicated to be applied. In some embodiments, the further syntax element indicates a target filter to be used. In some embodiments, the further syntax element indicates a method to derive a target filter.

In some embodiments, a filter selection regarding the plurality of filters I derived at both an encoder and a decoder. In some embodiments, a cost is calculated corresponding to a target filter and the target filter selection is applied according to the cost of each filter. In some embodiments, a target filter with a smallest cost is selected.

In some embodiments, a cost of a target filter is derived as one of the following of reconstruction samples of the second color component at a first set of positions and corresponding prediction values at the first set of positions: a sum of absolute difference (SAD), a sum of squared difference (SSD), a sum of absolute transformed difference (SATD), or a mean removal SAD (MR-SAD).

In some embodiments, the first set of positions include sample positions neighbouring to the video unit. In some embodiments, the sample positions are left to the video unit, and/or the sample positions are above to the video unit, the samples positions are left-above to the video unit, the sample positions are above-right to the video unit, or the sample positions are left-bottom to the video unit. In some embodiments, the first set of sample positions depends on availability of neighbouring samples. In some embodiments, a set of samples comprises available samples, or the set of samples comprises samples left to the video unit if a left neighbouring block is available, or the set of samples comprises samples above to the video unit if a above neighbouring block is available.

In some embodiments, the neighbouring samples are adjacent to the video unit or non-adjacent to the video unit. In some embodiments, herein the neighbouring samples include K rows of samples above the video unit, where K is an integer number. 82. In some embodiments, the neighbouring samples include K columns of samples left to the video unit, where K is an integer number.

In some embodiments, prediction values are derived using a target filter. In some embodiments, the target filter is used to generate samples of the first color component corresponding to reconstruction samples of the second color component at a second set of positions. In some embodiments, the generated samples and the reconstructed samples are used to derive at least one linear model for the target filter. In some embodiments, the at least one linear model is generated using a LMSE approach or a min-max approach. 87. In some embodiments, the at least one linear model is generated using an approach in multi-model based cross-component linear model chroma intra-prediction for video coding (MMLM).

In some embodiments, the at least one linear model is applied to generate a prediction value of a sample of the second color component at a position in the first set of positions. In some embodiments, the prediction value is derived as: P(x, y)=a*S(x,y)+b, and where (x, y) represents the position, P(x,y) represents the prediction value, S(x,y) represents a corresponding luma sample, and (a, b) represents the at least one linear model.

In some embodiments, an extra operation is applied to derive the prediction value with the at least one linear model. In some embodiments, the extra operation comprises at least one of: a shifting or clipping.

In some embodiments, whether to derive or use the at least one linear model depends on a coding mode of the video unit. In some embodiments, if a CCLM mode is applied, one mode is derived/used to generate prediction values. In some embodiments, if a MMLM mode is applied, one mode is derived/used to generate the prediction values.

In some embodiments, the first set of the positions and the second set of positions are the same. In some embodiments, the first set of the positions and the second set of positions are different. In some embodiments, the first set of the positions comprises at least one of: two rows of samples above the video unit or two columns of samples left to the video unit. In some embodiments, the second set of the positions comprises at least one of: one row of samples above the video unit or one column of samples left to the video unit.

In some embodiments, at least one of: the first set of the positions or the second set of positions depends on a coding mode of the video unit. In some embodiments, at least one of: the first set of the positions or the second set of positions comprises samples left to the video unit if the coding mode is CCLM-L. In some embodiments, at least one of: the first set of the positions or the second set of positions comprises samples above to the video unit if the coding mode is CCLM-T.

In some embodiments, multi-stage filters are applied. In some embodiments, samples of the first color component are filtered by a first filter to generate a first set of filtered samples, and the first set of filtered samples are filtered by a second filter to generate a second set of filtered samples. In some embodiments, the second set of filtered samples are used in a process of CCLM as the samples of the first color component corresponding to samples in the second color component. In some embodiments, the second set of filtered samples are further filtered by a third filter to generate a third set of filtered samples. In some embodiments, the third set of filtered samples are used in a process of CCLM as the samples of the first color component corresponding to samples in the second color component. In some embodiments, the third set of filtered samples are further filtered.

In some embodiments, if a color format is not 4:4:4, a re-sampling process is associated with any stage of the plurality of filters. If the color format is not 4:4:4, i.e., the resolution of the first component and that of the second component are different, the re-sampling (e.g. down-sampling) process may associated with any stage of the filters.

In some embodiments, samples involved in the n-th filtering stage are at one or more of the following positions: P0:(scaleX⁽ⁿ⁾*xC, scaleY⁽ⁿ⁾*yC), P1:(scaleX⁽ⁿ⁾*xC, scaleY⁽ⁿ⁾*yC+1), P2:(scaleX⁽ⁿ⁾*xC, scaleY⁽ⁿ⁾*yC−1), P3:(scaleX⁽ⁿ⁾*xC+1, scaleY⁽ⁿ⁾*yC), P4:(scaleX⁽ⁿ⁾*xC+1, scaleY⁽ⁿ⁾*yC+1), P5:(scaleX ⁽ⁿ⁾*xC+1, scaleY⁽ⁿ⁾*yC−1), wherein scaleX⁽ⁿ⁾and scaleY⁽ⁿ⁾ represent a scaling ratio of samples before the n-th filtering and samples of the second color component, (xC, yC) represent a position of a sample in the second color component, and n is an integer number. In some embodiments, if the samples before the n-th filtering and the samples of the second color component have the same resolution, scaleX⁽ⁿ⁾and scale Y (n) equal to 1.

In some embodiments, a target filter in one stage is fixed. In some embodiments, a target filter in one stage is adaptive. In some embodiments, the filter is selected from a set of candidate filters. In some embodiments, the filter is derived on-line. In some embodiments, the filter is indicated from an encoder to a decoder.

In some embodiments, a two-stage filtering is applied. In some embodiments, in a first stage, a luma sample corresponding to a position of a chroma component is filtered and down-sampled. In some embodiments, in the first stage, the luma sample are filtered and down-sampled with the filtering method defined in VVC, i.e. corresponding to a position (i, j) of the chroma component when the color format is 4:2:0 a color format is 4:2:0, the filtered luma sample is obtained by:

$${S}^{′} ( i , j ) = [ \begin{matrix}S ( 2 i - 1 , 2 j - 1 ) + 2 \cdot S ( 2 i - 1 , 2 j - 1 ) + \\ S ( 2 i + 1 , 2 j - 1 ) + S ( 2 i - 1 , 2 j ) + 2 \cdot \\ S ( 2 i , 2 j ) + S ( 2 i + 1 , 2 j ) + 4\end{matrix} ] ≫ 3$$

where S′^{(i,j)} represents the filtered luma and (i, j) represents the position.

In some embodiments, the filtered luma sample is further filtered adaptively. In some embodiments, the target filter is a filter in a stage of a multi-stage filtering. In one example, any method on filters disclosed in this document can be applied to a filter in any stage of the multiple-stage filtering.

In some embodiments, if Luma Mapping with Chroma Scaling (LMCS) is applied, samples of the first color component to be filtered are in an original domain. In some embodiments, if LMCS is applied, the samples of the first color component to be filtered are in a converted domain.

In some embodiments, samples of the first color component are filtered in different ways, if the samples are used in the in the process of CCLM. In some embodiments, a first filter is applied on a second color component, while a second filter is applied on a third component. In some embodiments, a derivation process of a target filter is performed individually for Cb component and Cr component. In some embodiments, a filter index of the target filter is indicated individually for Cb component and Cr component.

In some embodiments, if samples of the first color component are used in a process of CCLM, samples of the first color component are filtered in a same way. In some embodiments, a first filter is applied on a second color component, and the first filter is applied on a third component. In some embodiments, a derivation process of a target filter is performed for both Cb component and Cr component. In some embodiments, the derivation process depends on samples of one of Cb component and Cr component. In some embodiments, the derivation process depends on samples of both Cb component and Cr component. In some embodiments, a filter index of the target filter is indicated for both Cb component and Cr component.

In some embodiments, an indication of whether to and/or how to generate the sample value in the first color component by applying the plurality of filters is indicated at one of the followings:sequence level, group of pictures level, picture level, slice level, or tile group level. In some embodiments, an indication of whether to and/or how to generate the sample value in the first color component by applying the plurality of filters is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to generate the sample value in the first color component by applying the plurality of filters is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method further comprises determining, based on coded information of the video unit, whether and/or how to generate the sample value in the first color component by applying the plurality of filters. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: generating a sample value of a first color component of a video unit of the video that is corresponding to a sample of a second color component by applying a plurality of filters to at least one sample of the first color component; and generating the bitstream based on the generated sample value.

According to still further embodiments of the present disclosure, a method for storing bitstream of a video is provided. The method comprises: generating a sample value of a first color component of a video unit of the video that is corresponding to a sample of a second color component by applying a plurality of filters to at least one sample of the first color component; generating the bitstream based on the generated sample value; and storing the bitstream in a non-transitory computer-readable recording medium.

Implementations of the present disclosure can be described in view of the following clauses, the features of which can be combined in any reasonable manner.
Clause 1. A method of video processing, comprising: generating, for a conversion between a video unit of a video and a bitstream of the video unit, a sample value of a first color component of the video unit that is corresponding to a sample of a second color component by applying a plurality of filters to at least one sample of the first color component; and performing the conversion based on the generated sample value.
Clause 2. The method of clause 1, wherein the plurality of filters is applied in a process of cross-component linear model prediction of the video unit.
Clause 3. The method of clause 1, wherein a target filter of the plurality of filters is derived as: F(Y)=(c₀×S₀+c₁×S₁+ . . . . Cₙ×Sₙ+offset)»K, and wherein F(Y) represents the target filter, {Y} represents a set of samples of the first color component, n represents the number of taps of the target filter, cᵢ represents a filter coefficient of filter tap i, Sᵢ represents a value of the i-th sample of the first color component involved in represents, i is an integer and offset and K are integers respectively.
Clause 4. The method of clause 1, wherein at least one non-linear item involved in a target filter of the plurality of filters is denoted as: F(Y)=(c₀×S₀+C₁×S₁+ . . . . Cₙ×Sₙ+g (S₀, S₁, . . . , Sₙ)+offset)»K, and wherein F(Y) represents the target filter, {Y} represents a set of samples of the first color component, n represents the number of taps of the target filter, cᵢ represents a filter coefficient of filter tap i, Sᵢ represents a value of the i-th sample of the first color component involved in represents, and offset and K are integers respectively, g represents a non-linear function.
Clause 5. The method of clause 4, wherein g(S) is one of: log(S) or S² or S³ or S^{w}, or ″VS, and wherein w is an integer.
Clause 6. The method of clause 1, wherein a filtered result after the plurality of filters is clipped.
Clause 7. The method of clause 3 or 4, wherein the filter coefficient of filter tap is an integer, and the filter coefficient of filter tap is positive, negative or zero.
Clause 8. The method of clause 3 or 4, wherein a sum of cᵢ or |cᵢ| is a fixed number, wherein cᵢ represents the filter coefficient of filter tap i.
Clause 9. The method of clause 8, wherein the sum is 2^{K}, wherein K is an integer.
Clause 10. The method of clause 3 or 4, wherein the offset is equal to 2^{K-1}, wherein K is an integer.
Clause 11. The method of clause 1, wherein positions of samples of the first color component involved in a target filter of the plurality of filters depends on a position of the sample of the second color component.
Clause 12. The method of clause 1, wherein positions of samples of the first color component involved in a target filter of the plurality of filters depends on a color format.
Clause 13. The method of clause 12, wherein the color format is one of: 4:4:4 or 4:2:0 or 4:2:2.
Clause 14. The method of clause 1, wherein for K samples of the second color component, a target filter in the plurality of filters generates K corresponding samples of the first color component, where in K is an integer.
Clause 15. The method of clause 14, wherein for color format being 4:2:0 or 4:2:2, the target filter comprises a process of down-sampling or down-scaling when the first color component is Y and the second color component is Cb or Cr.
Clause 16. The method of clause 1, wherein xL=scaleX*xC+OffX, and/or yL=scaleY*yC+OffY, and wherein xC, yC represent a position of a specific sample in the second color component, xL, yL represent a position of the i-th sample in the first color component involved in a target filer of the plurality of filter corresponding to the specific sample, and scaleX and scaleY are scale factors, respectively.
Clause 17. The method of clause 16, wherein scaleX and scaleY depends on a color format.
Clause 18. The method of clause 17, wherein for the color format being 4:2:0, scaleX and scale Y equal to 2, or for the color format being 4:2:2, scaleX equal to 2 and scaleY equals to 1, or for the color format being 4:4:4, scaleX and scaleY equal to 1.
Clause 19. The method of clause 16, wherein OffX and OffY depend on a sequence value (i) of the sample and are integers.
Clause 20. The method of clause 16, wherein samples in the first color component that is involved in the target filter corresponding to the specific sample in the second color component are at one or more of the following positions: P0:(scaleX*xC, scaleY*yC), P1:(scaleX*xC, scaleY*yC+1), P2:(scaleX*xC, scaleY*yC−1), P3:(scaleX*xC+1, scaleY*yC), P4:(scaleX*xC+1, scaleY*yC+1), P5:(scaleX*xC+1, scaleY*yC−1), P6:(scaleX*xC−1, scaleY*yC), P7:(scaleX*xC−1, scaleY*yC+1), and P8:(scaleX *xC−1, scaleY*yC−1), and wherein P0, P1, P2, P3, P4, P5, P6, P7 and P8 represent the positions, xC, yC represent a position of a specific sample in the second color component, xL, yL represent a position of the i-th sample in the first color component involved in a target filer of the plurality of filter corresponding to the specific sample, and scaleX and scaleY are scale factors, respectively.
Clause 21. The method of clause 20, wherein the samples in the first color component that is involved the target filter with 6 taps corresponding to the specific sample in the second color component are at the positions P0, P1, P3, P4, P6, P7.
Clause 22. The method of clause 16, wherein positions of samples involved in the target filter depends on a color format.
Clause 23. The method of clause 16, wherein positions of samples involved in the target filter depends on at least one of: the first or the second color component.
Clause 24. The method of clause 16, wherein positions of samples involved in the target filter depends on a position of a current block.
Clause 25. The method of clause 24, wherein the position of the current block is at a boundary of one of: a picture, a slice, tile, a coding tree unit (CTU), or a CTU line.
Clause 26. The method of clause 16, wherein positions of samples involved in the target filter depends on a type of cross component linear model (CCLM) of the video unit.
Clause 27. The method of clause 26, wherein the type of CCLM comprises at oner of: a regular CCLM, a CCLM-L, a CCLM-T, a CCLM-LT, or a multi-model CCLM.
Clause 28. The method of clause 16, wherein a filter coefficient of a filter tap at a position is set to be 0, to remove the filter tap at the position.
Clause 29. The method of clause 16, wherein a sample involved in the target filter is removed from a filtering process if the sample is not available.
Clause 30. The method of clause 29, wherein the sample involved in the target filter is padded from a filtering process if the sample is not available.
Clause 31. The method of clause 30, wherein the sample is padded with a value of a nearest available sample of the sample.
Clause 32. The method of clause 31, wherein the nearest available sample is involved in the target filter.
Clause 33. The method of clause 1, wherein a candidate filter set is predefined and at least one candidate filter from the candidate filter set is used to filter samples of the first color component.
Clause 34. The method of clause 33, wherein coefficients of the at least one of filter candidate are indicated from an encoder to a decoder.
Clause 35. The method of clause 34, wherein the coefficients are indicated in a predictive way.
Clause 36, The method of clause 34, wherein a coefficient is binarized as one of: a fixed-length code, a unary code, a truncated unary code, or an exponential Golomb code.
Clause 37. The method of clause 34, wherein the coefficients for Cb and Cr are different and separately indicated.
Clause 38. The method of clause 34, wherein the coefficients for Cb and Cr are same and indicated together.
Clause 39. The method of clause 33, wherein coefficients of the at least one of filter candidate are derived on-line.
Clause 40. The method of clause 39, wherein the coefficients are derived by a least mean square error (LMSE) method using decoded sample values.
Clause 41. The method of clause 39, wherein the on-line derivation of the coefficients is conducted for Cb and Cr separately, or the on-line derivation of the coefficients is shared by Cb and Cr.
Clause 42. The method of clause 33, wherein the candidate filter set is the same to code different color components.
Clause 43. The method of clause 33, wherein the candidate filter set is different to code different color components.
Clause 44. The method of clause 33, wherein the candidate filter set depends on coding information of the video unit.
Clause 45. The method of clause 44, wherein the coding information comprises at least one of: a coding mode, a slice type, a picture type, a width of the video unit, a height of the video unit, a color format of the video unit or a color component of the video unit.
Clause 46. The method of clause 1, wherein filter selection information regarding the plurality of filters are indicated from an encoder to a decoder.
Clause 47. The method of clause 46, wherein a syntax element is indicated in one of the followings to indicate a selected filter: a coding unit (CU), a prediction unit (PU), a transform unit (TU), a CTU, a slice, or a picture.
Clause 48. The method of clause 46, wherein the syntax element is coded with at least one coding context in arithmetic coding.
Clause 49. The method of clause 46, wherein the syntax element is coded with bypass coding.
Clause 50. The method of clause 46, wherein the syntax element is binarized as one of: a fixed-length code, a unary code, a truncated unary code, or an exponential Golomb code.
Clause 51. The method of clause 46, wherein the syntax element is coded in a predictive way.
Clause 52. The method of clause 46, wherein the syntax element is individually for at least two components, or wherein the syntax element is indicated for at least two components.
Clause 53. The method of clause 1, further comprising: determining whether a coding mode is applied during a multi-filter approach for a cross-component prediction of the video unit.
Clause 54. The method of clause 53, wherein whether the coding mode is allowed or not is indicated from an encoder to a decoder in one of the following: a sequence parameter set (SPS), a picture parameter set (PPS), a picture header, a slice headers, a CTU line, a CTU, or a CU.
Clause 55. The method of clause 53, wherein whether the coding mode is allowed or not depends on coding information.
Clause 56. The method of clause 55, wherein the coding mode is allowed if a specific mode is applied to the video unit.
Clause 57. The method of clause 56, wherein the specific mode comprises at least one of: a regular CCLM, a CCLM-L, a CCLM-T, a CCLM-LT, or a multi-model CCLM.
Clause 58. The method of clause 55, wherein the coding mode is allowed, if a width of the video unit and a height of the video unit satisfies one or more conditions.
Clause 59. The method of clause 58, wherein the one or more conditions comprises at least one of: W*H<=T1, W*H>=T2, max (W, H)<=T3, min (W, H)>=T4, or W*H is larger than a predetermined number, and wherein W represents the width of the video unit, H represents the height of the video unit, T1, T2, T3 and T4 are integer numbers.
Clause 60. The method of clause 55, wherein the coding mode X is allowed for a specific kind of slice type or a picture type, and/or the coding mode is allowed for a specific kind color format, and/or the coding mode is allowed for a specific color component, and/or the coding mode is allowed for a specific profile or level of a standard, and/or the coding mode is allowed if at least K neighboring samples are available, wherein K is an integer number.
Clause 61. The method of clause 53, wherein whether a syntax element is indicated depends on whether the coding mode X is applied.
Clause 62. The method of clause 61, wherein the syntax element is indicated if the coding mode is allowed.
Clause 63. The method of clause 61, wherein the syntax element is set to a default value if the coding mode is not allowed.
Clause 64. The method of clause 61, wherein the syntax element is indicated for one of: a picture, a slice, a CTU, a CU, a PU, or a TU.
Clause 65. The method of clause 61, wherein the syntax element is indicated individually for at least two components, and the at least two components are handled differently on whether to perform the multi-filter approach.
Clause 66. The method of clause 61, wherein the syntax element is indicated for at least two components, and the at least two components are handled in the same way on whether to perform the multi-filter approach.
Clause 67. The method of clause 61, wherein the syntax element is coded with at least one coding context in arithmetic coding, or wherein the syntax element is coded with bypass coding.
Clause 68. The method of clause 61, wherein a further syntax element related to the multi-filter approach for the cross-component prediction is indicated after the syntax element.
Clause 69. The method of clause 68, wherein the further syntax element is indicated only if the multi-filter approach is indicated to be applied.
Clause 70. The method of clause 68, wherein the further syntax element indicates a target filter to be used.
Clause 71. The method of clause 68, wherein the further syntax element indicates a method to derive a target filter.
Clause 72. The method of clause 1, wherein a filter selection regarding the plurality of filters I derived at both an encoder and a decoder.
Clause 73. The method of clause 72, wherein a cost is calculated corresponding to a target filter and the target filter selection is applied according to the cost of each filter.
Clause 74. The method of clause 73, wherein a target filter with a smallest cost is selected.
Clause 75. The method of clause 72, wherein a cost of a target filter is derived as one of the following of reconstruction samples of the second color component at a first set of positions and corresponding prediction values at the first set of positions: a sum of absolute difference (SAD), a sum of squared difference (SSD), a sum of absolute transformed difference (SATD), or a mean removal SAD (MR-SAD).
Clause 76. The method of clause 75, wherein the first set of positions include sample positions neighbouring to the video unit.
Clause 77. The method of clause 76, wherein the sample positions are left to the video unit, and/or the sample positions are above to the video unit, the samples positions are left-above to the video unit, the sample positions are above-right to the video unit, or the sample positions are left-bottom to the video unit.
Clause 78. The method of clause 76, wherein the first set of sample positions depends on availability of neighbouring samples.
Clause 79. The method of clause 78, wherein a set of samples comprises available samples, or the set of samples comprises samples left to the video unit if a left neighbouring block is available, or the set of samples comprises samples above to the video unit if a above neighbouring block is available.
Clause 80. The method of clause 78, wherein the neighbouring samples are adjacent to the video unit or non-adjacent to the video unit.
Clause 81. The method of clause 80, wherein the neighbouring samples include K rows of samples above the video unit, wherein K is an integer number.
Clause 82. The method of clause 80, wherein the neighbouring samples include K columns of samples left to the video unit, wherein K is an integer number.
Clause 83. The method of 75, wherein prediction values are derived using a target filter.
Clause 84. The method of clause 83, wherein the target filter is used to generate samples of the first color component corresponding to reconstruction samples of the second color component at a second set of positions.
Clause 85. The method of clause 84, wherein the generated samples and the reconstructed samples are used to derive at least one linear model for the target filter.
Clause 86. The method of clause 85, wherein the at least one linear model is generated using a LMSE approach or a min-max approach.
Clause 87. The method of clause 85, wherein the at least one linear model is generated using an approach in multi-model based cross-component linear model chroma intra-prediction for video coding (MMLM).
Clause 88. The method of clause 85, wherein the at least one linear model is applied to generate a prediction value of a sample of the second color component at a position in the first set of positions.
Clause 89. The method of clause 88, wherein the prediction value is derived as: P(x, y)=a*S(x,y)+b, and wherein (x, y) represents the position, P(x,y) represents the prediction value, S(x,y) represents a corresponding luma sample, and (a, b) represents the at least one linear model.
Clause 90. The method of clause 88, wherein an extra operation is applied to derive the prediction value with the at least one linear model.
Clause 91. The method of clause 90, wherein the extra operation comprises at least one of: a shifting or clipping.
Clause 92. The method of clause 85, wherein whether to derive or use the at least one linear model depends on a coding mode of the video unit.
Clause 93. The method of clause 92, wherein if a CCLM mode is applied, one mode is derived/used to generate prediction values.
Clause 94. The method of clause 92, wherein if a MMLM mode is applied, one mode is derived/used to generate the prediction values.
Clause 95. The method of clause 75, wherein the first set of the positions and the second set of positions are the same.
Clause 96. The method of clause 75, wherein the first set of the positions and the second set of positions are different.
Clause 97. The method of clause 96, wherein the first set of the positions comprises at least one of: two rows of samples above the video unit or two columns of samples left to the video unit.
Clause 98. The method of clause 96, wherein the second set of the positions comprises at least one of: one row of samples above the video unit or one column of samples left to the video unit.
Clause 99. The method of clause 75, wherein at least one of: the first set of the positions or the second set of positions depends on a coding mode of the video unit.
Clause 100. The method of clause 99, wherein at least one of: the first set of the positions or the second set of positions comprises samples left to the video unit if the coding mode is CCLM-L.
Clause 101. The method of clause 99, wherein at least one of: the first set of the positions or the second set of positions comprises samples above to the video unit if the coding mode is CCLM-T.
Clause 102. The method of clause 1, wherein multi-stage filters are applied.
Clause 103. The method of clause 102, wherein samples of the first color component are filtered by a first filter to generate a first set of filtered samples, and the first set of filtered samples are filtered by a second filter to generate a second set of filtered samples.
Clause 104. The method of clause 103, wherein the second set of filtered samples are used in a process of CCLM as the samples of the first color component corresponding to samples in the second color component.
Clause 105. The method of clause 103, wherein the second set of filtered samples are further filtered by a third filter to generate a third set of filtered samples.
Clause 106. The method of clause 105, wherein the third set of filtered samples are used in a process of CCLM as the samples of the first color component corresponding to samples in the second color component.
Clause 107. The method of clause 105, wherein the third set of filtered samples are further filtered.
Clause 108. The method of clause 102, wherein if a color format is not 4:4:4, a re-sampling process is associated with any stage of the plurality of filters.
Clause 109. The method of clause 102, wherein samples involved in the n-th filtering stage are at one or more of the following positions: P0:(scaleX⁽ⁿ⁾*xC, scaleY⁽ⁿ⁾*yC), P1:(scaleX⁽ⁿ⁾*xC, scaleY⁽ⁿ⁾*yC+1), P2:(scaleX⁽ⁿ⁾*xC, scaleY⁽ⁿ⁾*yC−1), P3:(scaleX⁽ⁿ⁾*xC+1, scaleY⁽ⁿ⁾*yC), P4:(scaleX⁽ⁿ⁾*xC+1, scaleY⁽ⁿ⁾*yC+1), P5:(scaleX⁽ⁿ⁾*xC+1, scaleY⁽ⁿ⁾*yC−1), wherein scaleX⁽ⁿ⁾and scaleY⁽ⁿ⁾ represent a scaling ratio of samples before the n-th filtering and samples of the second color component, (xC, yC) represent a position of a sample in the second color component, and n is an integer number.
Clause 110. The method of clause 109, wherein if the samples before the n-th filtering and the samples of the second color component have the same resolution, scaleX⁽ⁿ⁾and scaleY⁽ⁿ⁾equal to 1.
Clause 111. The method of clause 102, wherein a target filter in one stage is fixed.
Clause 112. The method of clause 102, wherein a target filter in one stage is adaptive.
Clause 113. The method of clause 112, wherein the filter is selected from a set of candidate filters, or wherein the filter is derived on-line, or wherein the filter is indicated from an encoder to a decoder.
Clause 114. The method of clause 102, wherein a two-stage filtering is applied.
Clause 115. The method of clause 114, wherein in a first stage, a luma sample corresponding to a position of a chroma component is filtered and down-sampled.
Clause 116. The method of clause 115, wherein if a color format is 4:2:0, the filtered luma sample is obtained by:

$${S}^{′} ( i , j ) = [ \begin{matrix}S ( 2 i - 1 , 2 j - 1 ) + 2 \cdot S ( 2 i - 1 , 2 j - 1 ) + \\ S ( 2 i + 1 , 2 j - 1 ) + S ( 2 i - 1 , 2 j ) + 2 \cdot \\ S ( 2 i , 2 j ) + S ( 2 i + 1 , 2 j ) + 4\end{matrix} ] ≫ 3$$

wherein S′(i,j) represents the filtered luma and (i, j) represents the position.
Clause 117. The method of clause 115, wherein the filtered luma sample is further filtered adaptively.
Clause 118. The method of any of clauses 1-117, wherein the target filter is a filter in a stage of a multi-stage filtering.
Clause 119. The method of clause 1, wherein if Luma Mapping with Chroma Scaling (LMCS) is applied, samples of the first color component to be filtered are in an original domain, or wherein if LMCS is applied, the samples of the first color component to be filtered are in a converted domain.
Clause 120. The method of clause 1, wherein samples of the first color component are filtered in different ways, if the samples are used in the in the process of CCLM.
Clause 121. The method of clause 120, wherein a first filter is applied on a second color component, while a second filter is applied on a third component.
Clause 122. The method of clause 120, wherein a derivation process of a target filter is performed individually for Cb component and Cr component.
Clause 123. The method of clause 120, wherein a filter index of the target filter is indicated individually for Cb component and Cr component.
Clause 124. The method of clause 1, wherein if samples of the first color component are used in a process of CCLM, samples of the first color component are filtered in a same way.
Clause 125. The method of clause 124, wherein a first filter is applied on a second color component, and the first filter is applied on a third component.
Clause 126. The method of clause 124, wherein a derivation process of a target filter is performed for both Cb component and Cr component.
Clause 127. The method of clause 126, wherein the derivation process depends on samples of one of Cb component and Cr component, or wherein the derivation process depends on samples of both Cb component and Cr component.
Clause 128. The method of clause 124, wherein a filter index of the target filter is indicated for both Cb component and Cr component.
Clause 129. The method of any of clauses 1-128, wherein an indication of whether to and/or how to generate the sample value in the first color component by applying the plurality of filters is indicated at one of the followings:sequence level, group of pictures level, picture level, slice level, or tile group level.
Clause 130. The method of any of clauses 1-128, wherein an indication of whether to and/or how to generate the sample value in the first color component by applying the plurality of filters is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.
Clause 131. The method of any of clauses 1-128, wherein an indication of whether to and/or how to generate the sample value in the first color component by applying the plurality of filters is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.
Clause 132. The method of any of clauses 1-128, further comprising: determining, based on coded information of the video unit, whether and/or how to generate the sample value in the first color component by applying the plurality of filters, the coded information including at least one of: a block size, a colour format, a single and/or dual tree partitioning, a colour component, a slice type, or a picture type.
Clause 133. The method of any of clauses 1-132, wherein the conversion includes encoding the video unit into the bitstream.
Clause 134. The method of any of clauses 1-132, wherein the conversion includes decoding the video unit from the bitstream.
Clause 135. An apparatus for video processing comprising a processor and a non-transitory memory with instructions thereon, wherein the instructions upon execution by the processor, cause the processor to perform a method in accordance with any of clauses 1-134.
Clause 136. A non-transitory computer-readable storage medium storing instructions that cause a processor to perform a method in accordance with any of clauses 1-134.
Clause 137. A non-transitory computer-readable recording medium storing a bitstream of a video which is generated by a method performed by an apparatus for video processing, wherein the method comprises: generating a sample value of a first color component of a video unit of the video that is corresponding to a sample of a second color component by applying a plurality of filters to at least one sample of the first color component; and generating the bitstream based on the generated sample value.
Clause 138. A method for storing a bitstream of a video, comprising: generating a sample value of a first color component of a video unit of the video that is corresponding to a sample of a second color component by applying a plurality of filters to at least one sample of the first color component; generating the bitstream based on the generated sample value; and storing the bitstream in a non-transitory computer-readable recording medium.

### Example Device

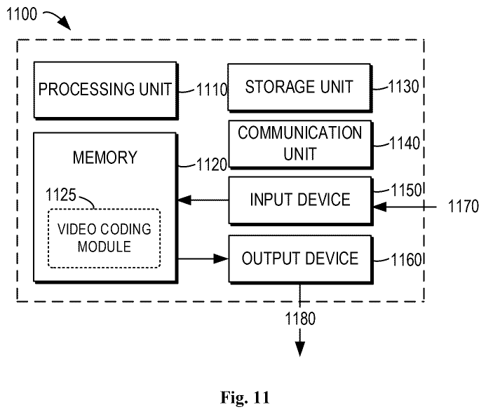

FIG. 11 illustrates a block diagram of a computing device 1100 in which various embodiments of the present disclosure can be implemented. The computing device 1100 may be implemented as or included in the source device 110 (or the video encoder 114 or 200) or the destination device 120 (or the video decoder 124 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device 1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement video encoding/decoding in embodiments of the present disclosure. The memory 1120 may include one or more video coding modules 1125 having one or more program instructions. These modules are accessible and executable by the processing unit 1110 to perform the functionalities of the various embodiments described herein.

In the example embodiments of performing video encoding, the input device 1150 may receive video data as an input 1170 to be encoded. The video data may be processed, for example, by the video coding module 1125, to generate an encoded bitstream. The encoded bitstream may be provided via the output device 1160 as an output 1180.

In the example embodiments of performing video decoding, the input device 1150 may receive an encoded bitstream as the input 1170. The encoded bitstream may be processed, for example, by the video coding module 1125, to generate decoded video data. The decoded video data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
generating, for a conversion between a video unit of a video and a bitstream of the video unit, a sample value of a first color component of the video unit that is corresponding to a sample of a second color component by applying a plurality of filters to at least one sample of the first color component; and
performing the conversion based on the generated sample value.

2. The method of claim 1, wherein the plurality of filters is applied in a process of cross-component linear model prediction of the video unit, and/or
wherein a target filter of the plurality of filters is derived as:
F(Y)=(c₀×S₀+C₁×S₁+ . . . Cₙ×Sₙ+offset)»K, and wherein F(Y) represents the target filter, {Y} represents a set of samples of the first color component, n represents a number of taps of the target filter, cᵢ represents a filter coefficient of filter tap i, Sᵢ represents a value of an i-th sample of the first color component involved in represents, i is an integer and offset and K are integers respectively, or
wherein at least one non-linear item involved in a target filter of the plurality of filters is denoted as:
F(Y)=(c₀×S₀+C₁×S₁+ . . . Cₙ×Sₙ+g (S₀, S₁, . . . , Sₙ)+offset)»K, and wherein F(Y) represents the target filter, {Y} represents a set of samples of the first color component, n represents the number of taps of the target filter, cᵢ represents a filter coefficient of filter tap i, Sᵢ represents a value of the i-th sample of the first color component involved in represents, and offset and K are integers respectively, g represents a non-linear function, or wherein a filtered result after the plurality of filters is clipped, or
wherein positions of samples of the first color component involved in a target filter of the plurality of filters depends on a position of the sample of the second color component, or
wherein positions of samples of the first color component involved in a target filter of the plurality of filters depends on a color format, or
wherein for K samples of the second color component, a target filter in the plurality of filters generates K corresponding samples of the first color component, wherein K is an integer, or
wherein xL=scaleX*xC+OffX, and/or yL=scale Y*yC+OffY, and wherein xC, yC represent a position of a specific sample in the second color component, xL, yL represent a position of the i-th sample in the first color component involved in a target filer of the plurality of filter corresponding to the specific sample, and scaleX and scaleY are scale factors, respectively, or
wherein a candidate filter set is predefined and at least one candidate filter from the candidate filter set is used to filter samples of the first color component.

3. The method of claim 2, wherein g(S) is one of: log(S) or S² or S³ or S^{w}, or
$$\sqrt[W]{S} ,$$
and wherein w is an integer, or
wherein the filter coefficient of filter tap is an integer, and the filter coefficient of filter tap is positive, negative or zero, or
wherein a sum of cᵢ or |cᵢ| is a fixed number, wherein cᵢ represents the filter coefficient of filter tap i, or
wherein the offset is equal to 2^{K-1}, wherein K is an integer, or
wherein the color format is one of: 4:4:4 or 4:2:0 or 4:2:2, or
wherein for color format being 4:2:0 or 4:2:2, the target filter comprises a process of down-sampling or down-scaling when the first color component is Y and the second color component is Cb or Cr, or wherein scaleX and scaleY depends on a color format, or
wherein OffX and OffY depend on a sequence value (i) of the sample and are integers, or
wherein samples in the first color component that is involved in the target filter corresponding to the specific sample in the second color component are at one or more of the following positions:
P0:(scaleX*xC, scale Y*yC),
P1:(scaleX*xC, scale Y*yC+1),
P2:(scaleX*xC, scale Y*yC−1),
P3:(scaleX*xC+1, scaleY*yC),
P4:(scaleX*xC+1, scaleY*yC+1),
P5:(scaleX*xC+1, scaleY*yC−1),
P6:(scaleX*xC−1, scaleY*yC),
P7:(scaleX*xC−1, scaleY*yC+1), and
P8:(scaleX*xC−1, scaleY*yC−1), and
wherein P0, P1, P2, P3, P4, P5, P6, P7 and P8 represent the positions, xC, yC represent a position of a specific sample in the second color component, xL, yL represent a position of the i-th sample in the first color component involved in a target filer of the plurality of filter corresponding to the specific sample, and scaleX and scaleY are scale factors, respectively, or
wherein positions of samples involved in the target filter depends on a color format, or
wherein positions of samples involved in the target filter depends on at least one of: the first or the second color component, or
wherein positions of samples involved in the target filter depends on a position of a current block, or wherein positions of samples involved in the target filter depends on a type of cross component linear model (CCLM) of the video unit, or
wherein a filter coefficient of a filter tap at a position is set to be 0, to remove the filter tap at the position, or
wherein a sample involved in the target filter is removed from a filtering process if the sample is not available, or
wherein coefficients of the at least one of filter candidate are indicated from an encoder to a decoder, or
wherein coefficients of the at least one of filter candidate are derived on-line, and/or
wherein the candidate filter set is the same to code different color components, or
wherein the candidate filter set is different to code different color components, or
wherein the candidate filter set depends on coding information of the video unit.

4. The method of claim 1, wherein filter selection information regarding the plurality of filters are indicated from an encoder to a decoder.

5. The method of claim 4, wherein a syntax element is indicated in one of the followings to indicate a selected filter: a coding unit (CU), a prediction unit (PU), a transform unit (TU), a CTU, a slice, or a picture, or
wherein the syntax element is coded with at least one coding context in arithmetic coding, or
wherein the syntax element is coded with bypass coding, or
wherein the syntax element is binarized as one of: a fixed-length code, a unary code, a truncated unary code, or an exponential Golomb code, or
wherein the syntax element is coded in a predictive way, or
wherein the syntax element is individually for at least two components, or
wherein the syntax element is indicated for at least two components.

6. The method of claim 1, further comprising:
determining whether a coding mode is applied during a multi-filter approach for a cross-component prediction of the video unit.

7. The method of claim 6, wherein whether the coding mode is allowed or not is indicated from an encoder to a decoder in one of the following: a sequence parameter set (SPS), a picture parameter set (PPS), a picture header, a slice headers, a CTU line, a CTU, or a CU, or
wherein whether the coding mode is allowed or not depends on coding information, or
wherein whether a syntax element is indicated depends on whether a coding mode X is applied.

8. The method of claim 7, wherein the syntax element is indicated if the coding mode is allowed, or
wherein the syntax element is set to a default value if the coding mode is not allowed, or
wherein the syntax element is indicated for one of: a picture, a slice, a CTU, a CU, a PU, or a TU, or
wherein the syntax element is indicated individually for at least two components, and the at least two components are handled differently on whether to perform the multi-filter approach, or
wherein the syntax element is indicated for at least two components, and the at least two components are handled in the same way on whether to perform the multi-filter approach, or
wherein the syntax element is coded with at least one coding context in arithmetic coding, or wherein the syntax element is coded with bypass coding, or
wherein a further syntax element related to the multi-filter approach for the cross-component prediction is indicated after the syntax element.

9. The method of claim 1, wherein a filter selection regarding a plurality of filters is derived at both an encoder and a decoder.

10. The method of claim 9, wherein a cost is calculated corresponding to a target filter and the target filter selection is applied according to the cost of each filter, or
wherein a cost of a target filter is derived as one of the following of reconstruction samples of the second color component at a first set of positions and corresponding prediction values at the first set of positions: a sum of absolute difference (SAD), a sum of squared difference (SSD), a sum of absolute transformed difference (SATD), or a mean removal SAD (MR-SAD).

11. The method of claim 10, wherein the first set of positions include sample positions neighbouring to the video unit, or
wherein prediction values are derived using a target filter, or
wherein the first set of the positions and the second set of positions are the same, or
wherein the first set of the positions and the second set of positions are different, or
wherein at least one of: the first set of the positions or the second set of positions depends on a coding mode of the video unit.

12. The method of claim 11, wherein the sample positions are left to the video unit, and/or the sample positions are above to the video unit, the samples positions are left-above to the video unit, the sample positions are above-right to the video unit, or the sample positions are left-bottom to the video unit, or
wherein the first set of sample positions depends on availability of neighbouring samples, or
wherein the target filter is used to generate samples of the first color component corresponding to reconstruction samples of the second color component at a second set of positions, or
wherein the first set of the positions comprises at least one of: two rows of samples above the video unit or two columns of samples left to the video unit.

13. The method of claim 11, wherein the second set of the positions comprises at least one of: one row of samples above the video unit or one column of samples left to the video unit.

14. The method of claim 11, wherein at least one of: the first set of the positions or the second set of positions comprises samples left to the video unit if the coding mode is CCLM-L.

15. The method of claim 11, wherein at least one of: the first set of the positions or the second set of positions comprises samples above to the video unit if the coding mode is CCLM-T.

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to:
generate, for a conversion between a video unit of a video and a bitstream of the video unit, a sample value of a first color component of the video unit that is corresponding to a sample of a second color component by applying a plurality of filters to at least one sample of the first color component; and
performing the conversion based on the generated sample value.

19. A non-transitory computer-readable storage medium storing instructions that cause a processor to:
generate, for a conversion between a video unit of a video and a bitstream of the video unit, a sample value of a first color component of the video unit that is corresponding to a sample of a second color component by applying a plurality of filters to at least one sample of the first color component; and
performing the conversion based on the generated sample value.

20. A non-transitory computer-readable recording medium storing a bitstream of a video which is generated by a method performed by an apparatus for video processing, wherein the method comprises:
generating a sample value of a first color component of a video unit of the video that is corresponding to a sample of a second color component by applying a plurality of filters to at least one sample of the first color component; and
generating the bitstream based on the generated sample value.
